(19) United States
(12) Patent Application Publication
(10) Pub. No.: US 2025/0110625 A1
(43) Pub. Date: Apr. 3, 2025

(54) TECHNIQUES FOR DISPLAYING DIFFERENT CONTROLS

(71) Applicant: Apple Inc., Cupertino, CA (US)

(72) Inventors: Arian BEHZADI, San Francisco, CA (US); Christopher P. FOSS, San Francisco, CA (US); Andrew S. KIM, Walnut Creek, CA (US); David A. KRIMSLEY, Sunnyvale, CA (US); Christopher D. MATTHEWS, San Francisco, CA (US); Corey K. WANG, Palo Alto, CA (US)

(21) Appl. No.: 18/896,514

(22) Filed: Sep. 25, 2024

Related U.S. Application Data
(60) Provisional application No. 63/541,815, filed on Sep. 30, 2023.
(60) Provisional application No. 63/541,820, filed on Sep. 30, 2023.
(60) Provisional application No. 63/541,806, filed on Sep. 30, 2023.

(51) Int. Cl. G06F 3/04845

(52) U.S. Cl. CPC G06F 3/04845

(57) ABSTRACT

The present disclosure generally relates to user interfaces and techniques for displaying different controls in accordance with some examples, such as displaying different controls, updating the background of a respective user interface that controls are displayed on, and/or displaying controls for different devices in accordance with some examples.

### CROSS-REFERENCE TO RELATED APPLICATIONS

This application claims the priority to U.S. Provisional Patent Application Ser. No. 63/541,815 entitled “TECHNIQUES FOR DISPLAYING DIFFERENT CONTROLS,” filed Sep. 30, 2023, to U.S. Provisional Patent Application Ser. No. 63/541,820 entitled “TECHNIQUES FOR CONTROLLING A DEVICE,” filed Sep. 30, 2023, and to U.S. Provisional Patent Application Ser. No. 63/541,806 entitled “USER INTERFACES FOR PERFORMING OPERATIONS,” filed Sep. 30, 2023, which are hereby incorporated by reference in their entireties for all purposes.

### FIELD

The present disclosure relates generally to computer user interfaces, and more specifically to techniques for displaying different types of controls.

### BACKGROUND

Computer systems often display different controls. The controls, when selected, can cause the computer system to transmit instructions to modify one or more statuses of one or more external computer systems.

### SUMMARY

Some techniques for displaying different controls using computer systems, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides computer systems with faster, more efficient methods and interfaces for displaying different controls. Such methods and interfaces optionally complement or replace other methods for displaying different controls. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a display component is described. In some embodiments, the method comprises: displaying, via the display component: a plurality of controls that includes a first control; and a representation of a scale at a respective position and with a first visual appearance; while displaying the plurality of controls that includes the first control and the representation of the scale at the respective position and with the first visual appearance, detecting an input directed to the first control; and in response to detecting the input directed to the first control: in accordance with a determination that the first control is a first type of control, displaying, via the display component, the representation of the scale with a second visual appearance that is different from the first visual appearance while continuing to display the representation of the scale at the respective location and the plurality of controls; and in accordance with a determination that the first control is a second type of control that is different from the first type of control: displaying, via the display component, the representation of the scale with a third visual appearance that is different from the first visual appearance while continuing to display the representation of the scale at the respective location; and ceasing to display at least one control of the plurality of controls.

In some embodiments, a non-transitory computer-readable storage medium storing one or more programs configured to be executed by one or more processors of a computer system that is in communication with a display component is described. In some embodiments, the one or more programs includes instructions for: displaying, via the display component: a plurality of controls that includes a first control; and a representation of a scale at a respective position and with a first visual appearance; while displaying the plurality of controls that includes the first control and the representation of the scale at the respective position and with the first visual appearance, detecting an input directed to the first control; and in response to detecting the input directed to the first control: in accordance with a determination that the first control is a first type of control, displaying, via the display component, the representation of the scale with a second visual appearance that is different from the first visual appearance while continuing to display the representation of the scale at the respective location and the plurality of controls; and in accordance with a determination that the first control is a second type of control that is different from the first type of control: displaying, via the display component, the representation of the scale with a third visual appearance that is different from the first visual appearance while continuing to display the representation of the scale at the respective location; and ceasing to display at least one control of the plurality of controls.

In some embodiments, a transitory computer-readable storage medium storing one or more programs configured to be executed by one or more processors of a computer system that is in communication with a display component is described. In some embodiments, the one or more programs includes instructions for: displaying, via the display component: a plurality of controls that includes a first control; and a representation of a scale at a respective position and with a first visual appearance; while displaying the plurality of controls that includes the first control and the representation of the scale at the respective position and with the first visual appearance, detecting an input directed to the first control; and in response to detecting the input directed to the first control: in accordance with a determination that the first control is a first type of control, displaying, via the display component, the representation of the scale with a second visual appearance that is different from the first visual appearance while continuing to display the representation of the scale at the respective location and the plurality of controls; and in accordance with a determination that the first control is a second type of control that is different from the first type of control: displaying, via the display component, the representation of the scale with a third visual appearance that is different from the first visual appearance while continuing to display the representation of the scale at the respective location; and ceasing to display at least one control of the plurality of controls.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: displaying, via the display component: a plurality of controls that includes a first control; and a representation of a scale at a respective position and with a first visual appearance; while displaying the plurality of controls that includes the first control and the representation of the scale at the respective position and with the first visual appearance, detecting an input directed to the first control; and in response to detecting the input directed to the first control: in accordance with a determination that the first control is a first type of control, displaying, via the display component, the representation of the scale with a second visual appearance that is different from the first visual appearance while continuing to display the representation of the scale at the respective location and the plurality of controls; and in accordance with a determination that the first control is a second type of control that is different from the first type of control: displaying, via the display component, the representation of the scale with a third visual appearance that is different from the first visual appearance while continuing to display the representation of the scale at the respective location; and ceasing to display at least one control of the plurality of controls.

In some embodiments, a computer system that is in communication with a display component is described. In some embodiments, the computer system that is in communication with a display component comprises means for performing each of the following steps: displaying, via the display component: a plurality of controls that includes a first control; and a representation of a scale at a respective position and with a first visual appearance; while displaying the plurality of controls that includes the first control and the representation of the scale at the respective position and with the first visual appearance, detecting an input directed to the first control; and in response to detecting the input directed to the first control: in accordance with a determination that the first control is a first type of control, displaying, via the display component, the representation of the scale with a second visual appearance that is different from the first visual appearance while continuing to display the representation of the scale at the respective location and the plurality of controls; and in accordance with a determination that the first control is a second type of control that is different from the first type of control: displaying, via the display component, the representation of the scale with a third visual appearance that is different from the first visual appearance while continuing to display the representation of the scale at the respective location; and ceasing to display at least one control of the plurality of controls.

In some embodiments, a computer program product is described. In some embodiments, the computer program product comprises one or more programs configured to be executed by one or more processors of a computer system that is in communication with a display component. In some embodiments, the one or more programs include instructions for: displaying, via the display component: a plurality of controls that includes a first control; and a representation of a scale at a respective position and with a first visual appearance; while displaying the plurality of controls that includes the first control and the representation of the scale at the respective position and with the first visual appearance, detecting an input directed to the first control; and in response to detecting the input directed to the first control: in accordance with a determination that the first control is a first type of control, displaying, via the display component, the representation of the scale with a second visual appearance that is different from the first visual appearance while continuing to display the representation of the scale at the respective location and the plurality of controls; and in accordance with a determination that the first control is a second type of control that is different from the first type of control: displaying, via the display component, the representation of the scale with a third visual appearance that is different from the first visual appearance while continuing to display the representation of the scale at the respective location; and ceasing to display at least one control of the plurality of controls.

In some embodiments, a method that is performed at a computer system that is in communication with a display component is described. In some embodiments, the method comprises: displaying, via the display component, a first user interface that includes: a plurality of controls, including a first control and a second control; a representation of a first value; and a first background that has a first visual appearance; while displaying the first user interface that includes the plurality of the controls, the representation of the first value, and the first background that has the first visual appearance, detecting an input directed to the first control; in response to detecting the input directed to the first control, displaying, via the display component, a second user interface that includes: the plurality of controls; a representation of a second value that is different from the representation of the first value; and a second background that has a second visual appearance without having the first visual appearance; while displaying the second user interface that includes the plurality of the controls, the representation of the second value, and the second background that has the second visual appearance, detecting a request to change the second value to a third value that is different from the second value; in response to detecting the request to change the second value to the third value, displaying a representation of a third value without displaying the representation of the second value; while displaying the plurality of controls, the representation of the third value, and the second background that has the second visual appearance, detecting an input directed to the second control; and in response to detecting the second control, displaying a modified version of the first user interface that includes the plurality of controls, the representation of the first value, and the first background, wherein the first background has a third visual appearance that is different from the first visual appearance and the second visual appearance, without having the first visual appearance and the second visual appearance.

In some embodiments, a non-transitory computer-readable storage medium storing one or more programs configured to be executed by one or more processors of a computer system that is in communication with a display component is described. In some embodiments, the one or more programs includes instructions for: displaying, via the display component, a first user interface that includes: a plurality of controls, including a first control and a second control; a representation of a first value; and a first background that has a first visual appearance; while displaying the first user interface that includes the plurality of the controls, the representation of the first value, and the first background that has the first visual appearance, detecting an input directed to the first control; in response to detecting the input directed to the first control, displaying, via the display component, a second user interface that includes: the plurality of controls; a representation of a second value that is different from the representation of the first value; and a second background that has a second visual appearance without having the first visual appearance; while displaying the second user interface that includes the plurality of the controls, the representation of the second value, and the second background that has the second visual appearance, detecting a request to change the second value to a third value that is different from the second value; in response to detecting the request to change the second value to the third value, displaying a representation of a third value without displaying the representation of the second value; while displaying the plurality of controls, the representation of the third value, and the second background that has the second visual appearance, detecting an input directed to the second control; and in response to detecting the second control, displaying a modified version of the first user interface that includes the plurality of controls, the representation of the first value, and the first background, wherein the first background has a third visual appearance that is different from the first visual appearance and the second visual appearance, without having the first visual appearance and the second visual appearance.

In some embodiments, a transitory computer-readable storage medium storing one or more programs configured to be executed by one or more processors of a computer system that is in communication with a display component is described. In some embodiments, the one or more programs includes instructions for: displaying, via the display component, a first user interface that includes: a plurality of controls, including a first control and a second control; a representation of a first value; and a first background that has a first visual appearance; while displaying the first user interface that includes the plurality of the controls, the representation of the first value, and the first background that has the first visual appearance, detecting an input directed to the first control; in response to detecting the input directed to the first control, displaying, via the display component, a second user interface that includes: the plurality of controls; a representation of a second value that is different from the representation of the first value; and a second background that has a second visual appearance without having the first visual appearance; while displaying the second user interface that includes the plurality of the controls, the representation of the second value, and the second background that has the second visual appearance, detecting a request to change the second value to a third value that is different from the second value; in response to detecting the request to change the second value to the third value, displaying a representation of a third value without displaying the representation of the second value; while displaying the plurality of controls, the representation of the third value, and the second background that has the second visual appearance, detecting an input directed to the second control; and in response to detecting the second control, displaying a modified version of the first user interface that includes the plurality of controls, the representation of the first value, and the first background, wherein the first background has a third visual appearance that is different from the first visual appearance and the second visual appearance, without having the first visual appearance and the second visual appearance.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: displaying, via the display component, a first user interface that includes: a plurality of controls, including a first control and a second control; a representation of a first value; and a first background that has a first visual appearance; while displaying the first user interface that includes the plurality of the controls, the representation of the first value, and the first background that has the first visual appearance, detecting an input directed to the first control; in response to detecting the input directed to the first control, displaying, via the display component, a second user interface that includes: the plurality of controls; a representation of a second value that is different from the representation of the first value; and a second background that has a second visual appearance without having the first visual appearance; while displaying the second user interface that includes the plurality of the controls, the representation of the second value, and the second background that has the second visual appearance, detecting a request to change the second value to a third value that is different from the second value; in response to detecting the request to change the second value to the third value, displaying a representation of a third value without displaying the representation of the second value; while displaying the plurality of controls, the representation of the third value, and the second background that has the second visual appearance, detecting an input directed to the second control; and in response to detecting the second control, displaying a modified version of the first user interface that includes the plurality of controls, the representation of the first value, and the first background, wherein the first background has a third visual appearance that is different from the first visual appearance and the second visual appearance, without having the first visual appearance and the second visual appearance.

In some embodiments, a computer system that is in communication with a display component is described. In some embodiments, the computer system that is in communication with a display component comprises means for performing each of the following steps: displaying, via the display component, a first user interface that includes: a plurality of controls, including a first control and a second control; a representation of a first value; and a first background that has a first visual appearance; while displaying the first user interface that includes the plurality of the controls, the representation of the first value, and the first background that has the first visual appearance, detecting an input directed to the first control; in response to detecting the input directed to the first control, displaying, via the display component, a second user interface that includes: the plurality of controls; a representation of a second value that is different from the representation of the first value; and a second background that has a second visual appearance without having the first visual appearance; while displaying the second user interface that includes the plurality of the controls, the representation of the second value, and the second background that has the second visual appearance, detecting a request to change the second value to a third value that is different from the second value; in response to detecting the request to change the second value to the third value, displaying a representation of a third value without displaying the representation of the second value; while displaying the plurality of controls, the representation of the third value, and the second background that has the second visual appearance, detecting an input directed to the second control; and in response to detecting the second control, displaying a modified version of the first user interface that includes the plurality of controls, the representation of the first value, and the first background, wherein the first background has a third visual appearance that is different from the first visual appearance and the second visual appearance, without having the first visual appearance and the second visual appearance.

In some embodiments, a computer program product is described. In some embodiments, the computer program product comprises one or more programs configured to be executed by one or more processors of a computer system that is in communication with a display component. In some embodiments, the one or more programs include instructions for: displaying, via the display component, a first user interface that includes: a plurality of controls, including a first control and a second control; a representation of a first value; and a first background that has a first visual appearance; while displaying the first user interface that includes the plurality of the controls, the representation of the first value, and the first background that has the first visual appearance, detecting an input directed to the first control; in response to detecting the input directed to the first control, displaying, via the display component, a second user interface that includes: the plurality of controls; a representation of a second value that is different from the representation of the first value; and a second background that has a second visual appearance without having the first visual appearance; while displaying the second user interface that includes the plurality of the controls, the representation of the second value, and the second background that has the second visual appearance, detecting a request to change the second value to a third value that is different from the second value; in response to detecting the request to change the second value to the third value, displaying a representation of a third value without displaying the representation of the second value; while displaying the plurality of controls, the representation of the third value, and the second background that has the second visual appearance, detecting an input directed to the second control; and in response to detecting the second control, displaying a modified version of the first user interface that includes the plurality of controls, the representation of the first value, and the first background, wherein the first background has a third visual appearance that is different from the first visual appearance and the second visual appearance, without having the first visual appearance and the second visual appearance.

In some embodiments, a method that is performed at a computer system that is in communication with a display component is described. In some embodiments, the method comprises: displaying, via the display component, a first control for controlling a first type of device; while displaying the first control for controlling the first type of device, detecting an input directed to the first control; and in response to detecting the input directed to the first control, displaying, via the display component: a second control corresponding to a first device of the first type of device, wherein the first device corresponds to a first location; a third control corresponding to a second device of the first type of device, wherein the second device is different from the first device, and wherein the second device corresponds to a second location that is different from the first location; in accordance with a determination that presence of a user is detected at the first location, an indication that the second control is selected without displaying an indication that the third control is selected; and in accordance with a determination that presence of the user is detected at the second location, the indication that the third control is selected without displaying the indication that the second control is selected.

In some embodiments, a non-transitory computer-readable storage medium storing one or more programs configured to be executed by one or more processors of a computer system that is in communication with a display component is described. In some embodiments, the one or more programs includes instructions for: displaying, via the display component, a first control for controlling a first type of device; while displaying the first control for controlling the first type of device, detecting an input directed to the first control; and in response to detecting the input directed to the first control, displaying, via the display component: a second control corresponding to a first device of the first type of device, wherein the first device corresponds to a first location; a third control corresponding to a second device of the first type of device, wherein the second device is different from the first device, and wherein the second device corresponds to a second location that is different from the first location; in accordance with a determination that presence of a user is detected at the first location, an indication that the second control is selected without displaying an indication that the third control is selected; and in accordance with a determination that presence of the user is detected at the second location, the indication that the third control is selected without displaying the indication that the second control is selected.

In some embodiments, a transitory computer-readable storage medium storing one or more programs configured to be executed by one or more processors of a computer system that is in communication with a display component is described. In some embodiments, the one or more programs includes instructions for: displaying, via the display component, a first control for controlling a first type of device; while displaying the first control for controlling the first type of device, detecting an input directed to the first control; and in response to detecting the input directed to the first control, displaying, via the display component: a second control corresponding to a first device of the first type of device, wherein the first device corresponds to a first location; a third control corresponding to a second device of the first type of device, wherein the second device is different from the first device, and wherein the second device corresponds to a second location that is different from the first location; in accordance with a determination that presence of a user is detected at the first location, an indication that the second control is selected without displaying an indication that the third control is selected; and in accordance with a determination that presence of the user is detected at the second location, the indication that the third control is selected without displaying the indication that the second control is selected.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: displaying, via the display component, a first control for controlling a first type of device; while displaying the first control for controlling the first type of device, detecting an input directed to the first control; and in response to detecting the input directed to the first control, displaying, via the display component: a second control corresponding to a first device of the first type of device, wherein the first device corresponds to a first location; a third control corresponding to a second device of the first type of device, wherein the second device is different from the first device, and wherein the second device corresponds to a second location that is different from the first location; in accordance with a determination that presence of a user is detected at the first location, an indication that the second control is selected without displaying an indication that the third control is selected; and in accordance with a determination that presence of the user is detected at the second location, the indication that the third control is selected without displaying the indication that the second control is selected.

In some embodiments, a computer system that is in communication with a display component is described. In some embodiments, the computer system that is in communication with a display component comprises means for performing each of the following steps: displaying, via the display component, a first control for controlling a first type of device; while displaying the first control for controlling the first type of device, detecting an input directed to the first control; and in response to detecting the input directed to the first control, displaying, via the display component: a second control corresponding to a first device of the first type of device, wherein the first device corresponds to a first location; a third control corresponding to a second device of the first type of device, wherein the second device is different from the first device, and wherein the second device corresponds to a second location that is different from the first location; in accordance with a determination that presence of a user is detected at the first location, an indication that the second control is selected without displaying an indication that the third control is selected; and in accordance with a determination that presence of the user is detected at the second location, the indication that the third control is selected without displaying the indication that the second control is selected.

In some embodiments, a computer program product is described. In some embodiments, the computer program product comprises one or more programs configured to be executed by one or more processors of a computer system that is in communication with a display component. In some embodiments, the one or more programs include instructions for: displaying, via the display component, a first control for controlling a first type of device; while displaying the first control for controlling the first type of device, detecting an input directed to the first control; and in response to detecting the input directed to the first control, displaying, via the display component: a second control corresponding to a first device of the first type of device, wherein the first device corresponds to a first location; a third control corresponding to a second device of the first type of device, wherein the second device is different from the first device, and wherein the second device corresponds to a second location that is different from the first location; in accordance with a determination that presence of a user is detected at the first location, an indication that the second control is selected without displaying an indication that the third control is selected; and in accordance with a determination that presence of the user is detected at the second location, the indication that the third control is selected without displaying the indication that the second control is selected.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying different controls, thereby increasing the effectiveness, efficiency, and user satisfaction with such devices. Such methods and interfaces may complement or replace other methods for displaying different controls.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2J illustrate exemplary user interfaces for displaying controls in accordance with some examples.

FIGS. 3A-3B are a flow diagram illustrating a method for displaying different controls in accordance with some examples.

FIGS. 4A-4C are a flow diagram illustrating a method for updating the background of a respective user interface in accordance with some examples.

FIG. 5 is a flow diagram illustrating a method for displaying controls for different devices in accordance with some examples.

### DETAILED DESCRIPTION

The following description sets forth exemplary techniques for displaying different controls. This description is not intended to limit the scope of this disclosure but is instead provided as a description of example implementations.

Users need electronic devices that provide effective techniques for displaying different controls. Efficient techniques can reduce a user's mental load when accessing different controls. This reduction in mental load can enhance user productivity and make the device easier to use. In some embodiments, the techniques described herein can reduce battery usage and processing time (e.g., by providing user interfaces that require fewer user inputs to operate).

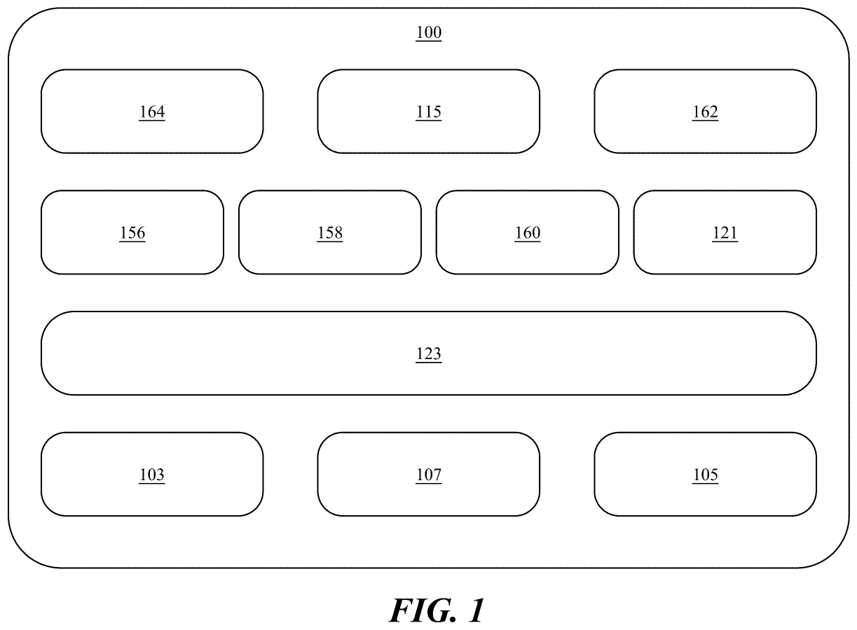

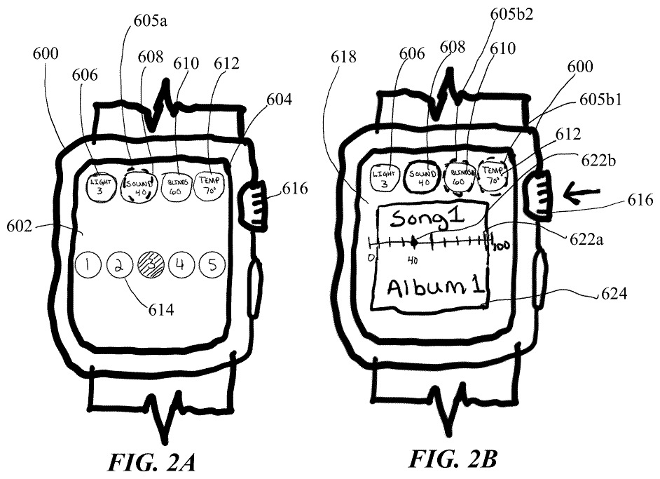

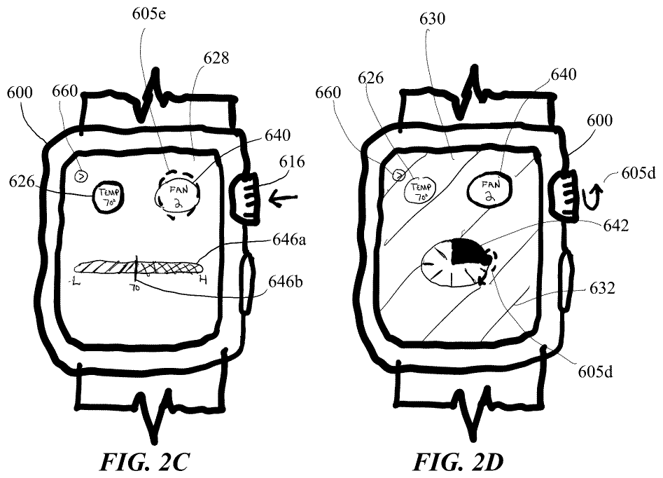

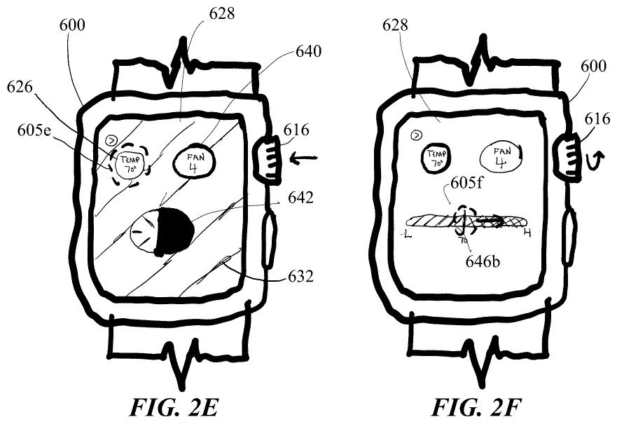

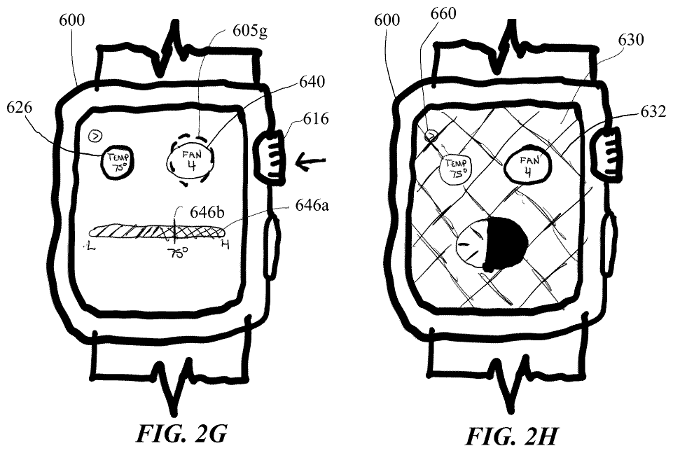

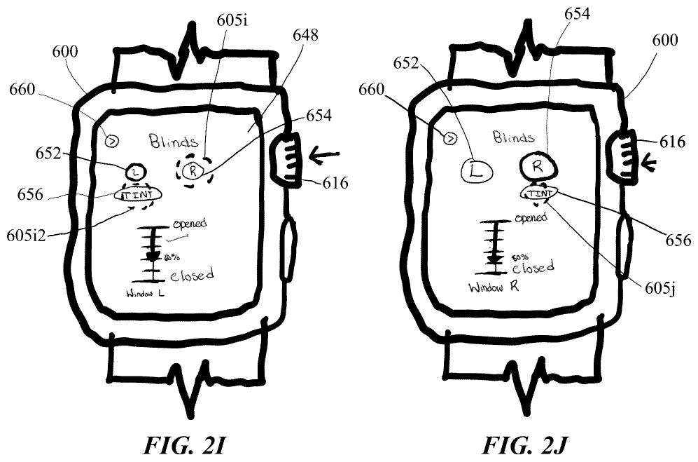

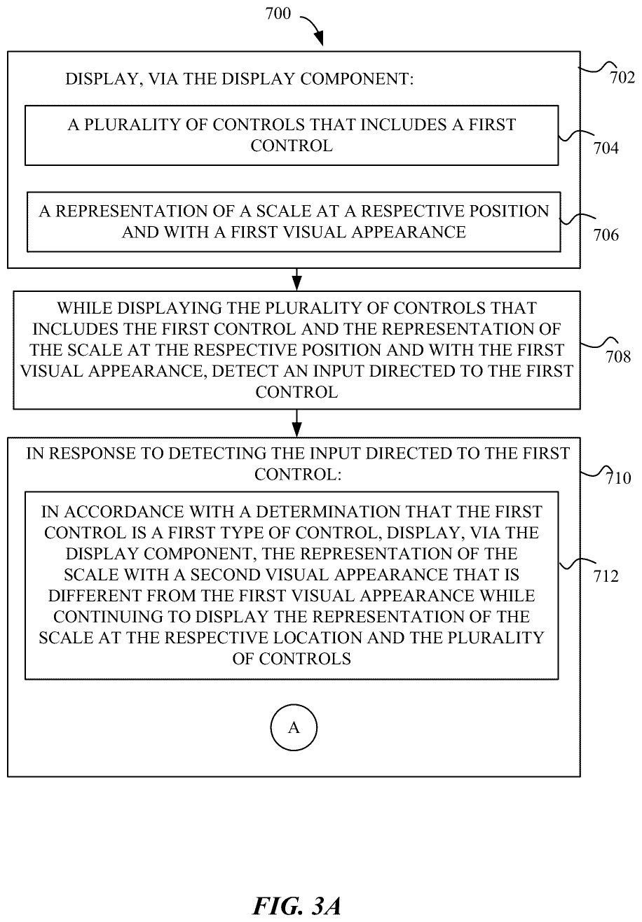

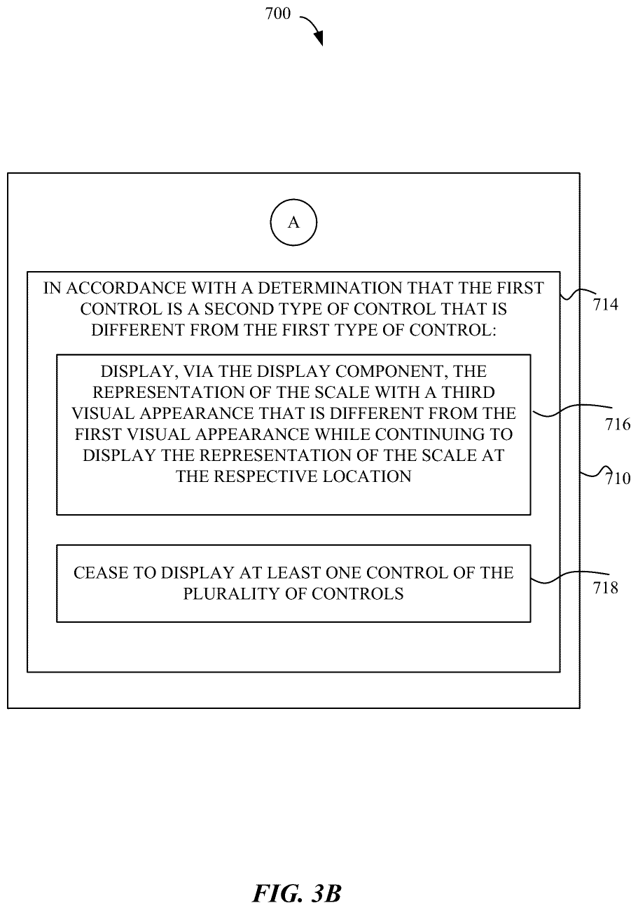

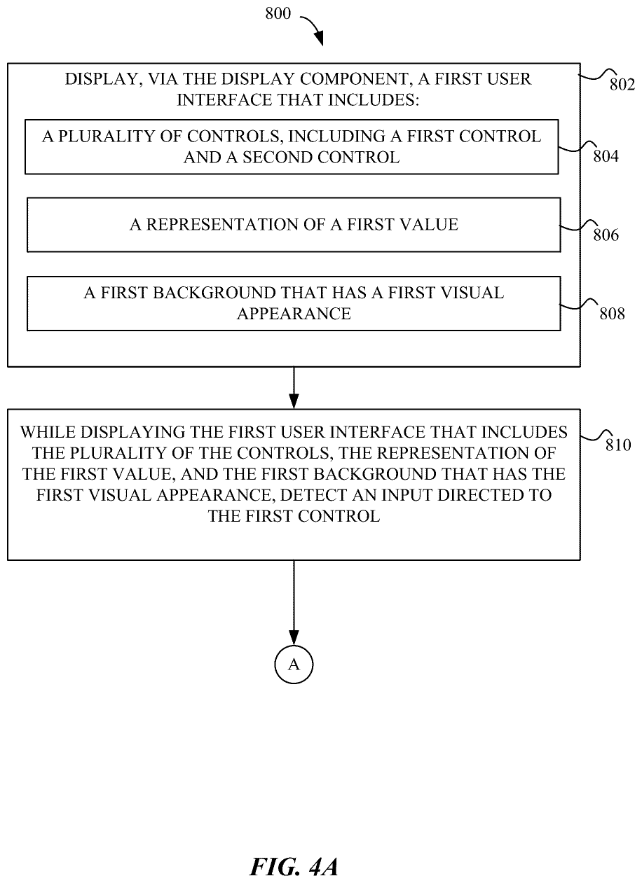

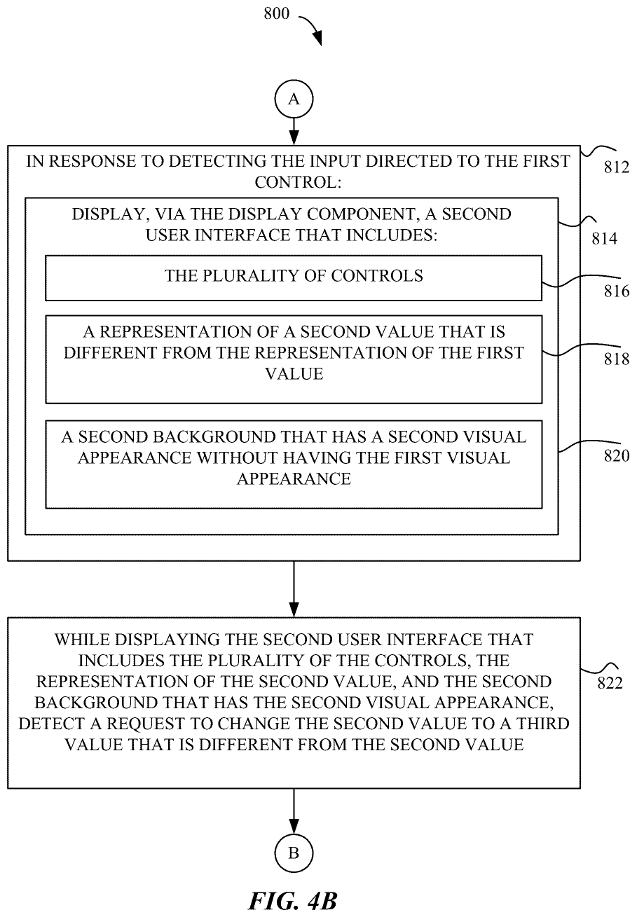

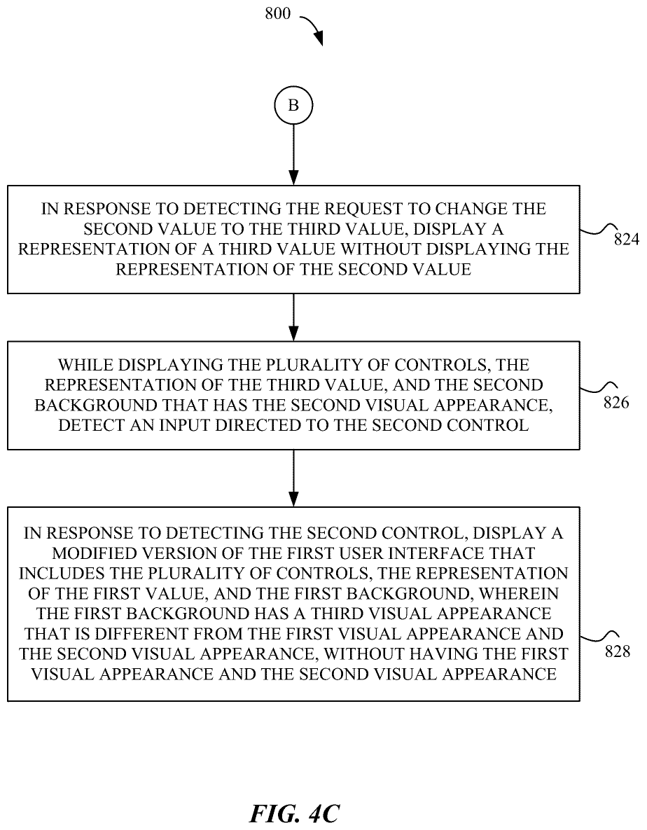

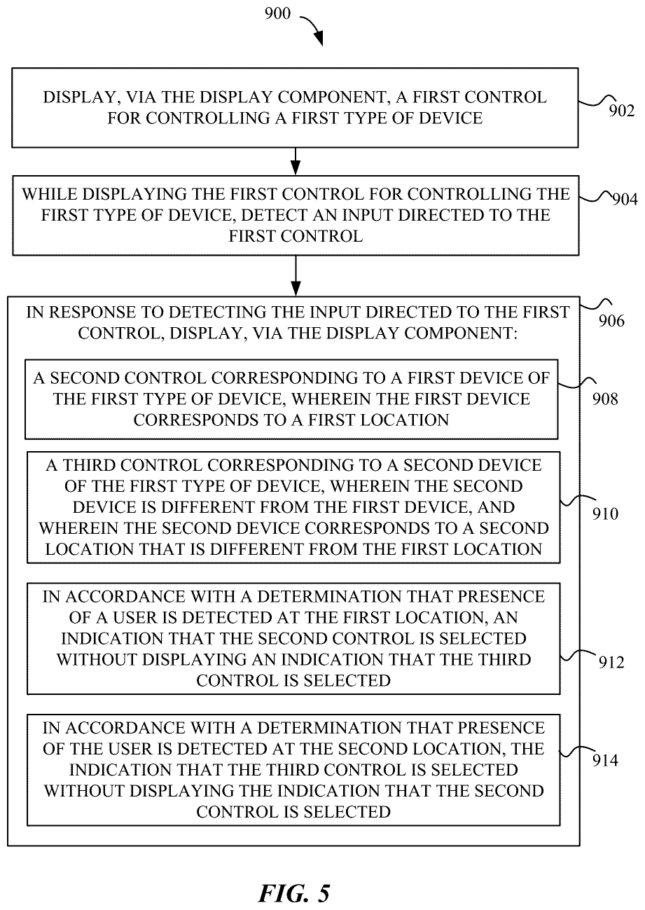

FIG. 1 provides illustrations of exemplary devices for performing techniques for displaying different controls. FIGS. 2A-2J illustrate exemplary user interfaces for displaying controls in accordance with some examples. FIGS. 3A-3B are a flow diagram illustrating methods of displaying different controls in accordance with some examples. FIGS. 4A-4C are a flow diagram illustrating methods of updating the background of a respective user interface in accordance with some examples. FIG. 5 is a flow diagram illustrating methods for displaying controls for different devices in accordance with some examples. The user interfaces in FIGS. 2A-2J are used to illustrate the processes described below, including the processes in FIGS. 3-5.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3, 4, and/or 5 (e.g., processes 700, 800, and/or 900) and/or portions of these methods.

In FIG. 1, system 100 includes various components, such as processor(s) 103, RF circuitry(ies) 105, memory(ies) 107, sensors 156 (e.g., image sensor(s), orientation sensor(s), location sensor(s), heart rate monitor(s), temperature sensor(s)), input device(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output device(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input device.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory(ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105 includes circuitry for communicating with electronic devices and/or networks (e.g., the Internet, intranets, and/or a wireless network, such as cellular networks and wireless local area networks (LANs)). In some embodiments, RF circuitry(ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery(ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105.

In some embodiments, system 100 is capable of communicating with other computer systems and/or electronic devices. For example, system 100 can use RF circuitry(ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry(ies) 105. In some embodiments, system 100 receives, using the RF circuitry(ies) 105, video and/or audio from the other system(s) in the videoconferencing communication sessions, and presents the video and/or audio using output device(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output device(s) 160. In some embodiments, output device(s) 160 generates the tactile outputs by displacing a moveable mass relative to a neutral position. In some embodiments, tactile outputs are periodic in nature, optionally including frequency(ies) and/or amplitude(s) of movement in two or three dimensions. In some embodiments, system 100 generates a variety of different tactile outputs differing in frequency(ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency(ies) corresponds to faster movement(s) by the moveable mass whereas lower frequency(ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input device(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input device(s) 158 to detect the user speaking one or more words. In some embodiments, system 100 parses and/or communicates information to one or more other systems to determine contents of the speech of the user, including identifying words and/or obtaining a semantic understanding of the words. For example, system processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output device(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry(ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as the system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry(ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Attention is now directed towards embodiments of user interfaces (“UI”) and associated processes that are implemented on an electronic device, such as system 100.

FIGS. 2A-2J illustrate exemplary user interfaces for displaying controls in accordance with some embodiments. The user interfaces in these figures are used to illustrate the processes described below, including the processes in FIGS. 3A-3B, 4A-4B, and 5.

FIG. 2A illustrates computer system 600, which is a smartwatch and includes display 604 (e.g., a display component) and rotatable input mechanism 616. It should be understood that the types of computer systems, user interfaces, user interface objects, and components described herein are merely exemplary and are provided to give context to the examples described herein. In some embodiments, computer system 600 includes a knob, a dial, a joystick, a touch-sensitive surface, a button, a slider, a television, a projector, a monitor, a smart display, a laptop, and/or a personal computer. In some embodiments, display 604 is positioned within rotatable input mechanism 616. In some embodiments, display 604 is positioned above, below, under, and/or over rotatable input mechanism 616. In some embodiments, rotatable input mechanism 616 is positioned on the surface of display 604. In some embodiments, one or more portions of display 604 are positioned around rotatable input mechanism 616, such that one or more user interface elements displayed via display 604 are displayed around rotatable input mechanism 616. In some embodiments, rotatable input mechanism 616 includes a display that is different from and/or separate from display 604.

As illustrated in FIG. 2A, computer system 600 displays light control user interface 602. Light control user interface 602 includes light control user interface object 606, volume control user interface object 608, blind control user interface object 610, and temperature control user interface object 612. Light control user interface object 606 corresponds to a light device (e.g., a light device that is external to a surface of computer system 600 and/or internal to a surface of computer system 600), volume control user interface object 608 corresponds to a playback device (e.g., a playback device, such as a speaker), blind control user interface object 610 corresponds to an external electronic window covering (e.g., an electronic window, such as smart blinds covering a window), and temperature control user interface object 612 corresponds to an heating and air conditioning (HVAC) device (e.g., a device capable of heating and/or cooling an area). In some embodiments, the light device, the playback device, the electronic window covering, and the HVAC device are each coupled to a common external structure (e.g., an airplane, a home, an office building, a car, and/or a boat). In some embodiments, computer system 600 is in communication (e.g., wireless communication (e.g., Bluetooth, Wi-Fi, and/or Ultrawideband) and/or wired communication) with each of the external playback device, the external window covering, the HVAC device and/or the external light device.

As illustrated in FIG. 2A, each of light control user interface object 606, volume control user interface object 608, blind control user interface object 610, and temperature control user interface object 612 include an indication of a current operation setting of its corresponding device. More specifically, light control user interface object 606 indicates that the light device is operating at a third brightness setting, volume control user interface object 608 indicates playback device is set to a volume setting of forty, blind control user interface object 610 indicates that the electronic window covering is 60% closed, and temperature control user interface object 612 indicates that the HVAC device is set to seventy degrees.

Further, as illustrated in FIG. 2A, light control user interface 602 includes light scale user interface object 614. Light scale user interface object 614 is a representation of the range of light settings of the light device (e.g., 1 to 5). Accordingly, the leftmost portion of light scale user interface object 614 represents the minimum light setting (e.g., 1, which corresponds to a light value of 0 (e.g., minimum brightness and/or light device is powered off)) of the light device and the rightmost portion of light scale user interface object 614 represents the maximum light setting (e.g., 5, which corresponds to a light value of 100 (e.g., maximum brightness)) of the light device. As illustrated in FIG. 2A, light scale user interface object 614 indicates that the light setting of 3 is selected (e.g., via the shading of “3” in comparison to the other numbers of light scale user interface object 614). In some embodiments, computer system 600 displays light scale user interface object 614 around rotatable input mechanism 616. In some embodiments, the light setting is a brightness setting, a color setting, a tone setting, and/or a light temperature setting.

At FIG. 2A, computer system 600 detects input 605a that corresponds to selection of volume control user interface object 608. In some embodiments, input 605a corresponds to a tap input, a long press (e.g., a tap and hold), a swipe input, a gaze, a voice command, a gaze, a depression of rotatable input mechanism 616, a rotation of rotatable input mechanism 616, and/or a hand gesture. In some embodiments, computer system 600 navigates (e.g., scrolls and/or moves) between light control user interface object 606, volume control user interface object 608, blind control user interface object 610, and temperature control user interface object 612 in response to detecting a rotation of rotatable input mechanism 616. In some embodiments, computer system 600 transmits instructions to the light device that cause the light device to adjust its brightness setting (e.g., in response to detecting a rotation of rotatable input mechanism 616 and/or while computer system 600 displays light control user interface 602). In some embodiments, volume control user interface object 608 is a global control that corresponds to one or more playback devices that are positioned throughout various areas of the external structure. Thus, in some embodiments, computer system 600 causes the volume level of multiple playback devices to be adjusted in response to detecting a request to update the volume setting (e.g., via one or more inputs to change volume control user interface object 608).

As illustrated in FIG. 2B, in response to detecting input 605a, computer system 600 ceases to display light control user interface 602 and displays media playback user interface 618. As illustrated in FIG. 2B, media playback user interface 618 includes light control user interface object 606, volume control user interface object 608, blind control user interface object 610, and temperature control user interface object 612. Moreover, in response to detecting input 605a, computer system 600 ceases displaying light scale user interface object 614. Thus, in response to detecting input 605a, computer system 600 continues to display light control user interface object 606, volume control user interface object 608, blind control user interface object 610, and temperature control user interface object 612 even though computer system 600 no longer displays light control user interface 602. At FIG. 2B, a determination is made that no sub controls are associated with volume control user interface object 608. Because of this determination, at FIG. 2B, computer system 600 does not display sub controls as part of displaying media playback user interface 618.

As illustrated in FIG. 2B, media playback user interface 618 also includes volume scale user interface object 622a, volume level indicator user interface object 622b, and media item representation user interface object 624. Volume scale user interface object 622a represents the range of volume settings of the playback device. The leftmost portion of volume scale user interface object 622a represents the minimum volume setting of the playback device and the rightmost portion represents the maximum volume setting of the playback device. Volume level indicator user interface object 622b indicates the current volume setting of the playback device. Accordingly, at FIG. 2B, the playback device is currently set to a volume setting of 40, which is indicated by volume scale indicator user interface object 622a and volume control user interface object 608. Media item representation user interface object 624 includes a textual and graphical representation (e.g., album art and/or song art) of a media item that the playback device is configured to playback and/or is currently playing back. In some embodiments, computer system 600 displays volume scale user interface object 622a around rotatable input mechanism 616. In some embodiments, computer system 600 adjusts the length of volume scale user interface object 622a (and/or displays and/or ceases to display a color, indication, and/or highlights one or more portions of an area surrounding a rotatable input mechanism that corresponds to volume scale user interface object 622a).

At FIG. 2B, computer system 600 detects input 605b1 that corresponds to a selection of temperature control user interface object 612 or computer system 600 detects input 605b2 that corresponds to selection of blind control user interface object 610. In some embodiments, temperature control user interface object 612 is a global control that corresponds to one or more HVAC devices that heats and/or cools multiple areas of an external structure. In some embodiments, input 605b1 and/or input 605b2 corresponds to a tap input, a long press (e.g., a tap and hold), a swipe input, a gaze, a voice command, a gaze, a depression of rotatable input mechanism 616, a rotation of rotatable input mechanism 616, and/or a hand gesture. In some embodiments, media playback user interface 618 does not include media item representation user interface object 624. In some embodiments, media playback user interface 618 does not include volume scale user interface object 622a. In some embodiments, media playback user interface 618 includes one or more playback controls (e.g., next media item control, previous media item control, play media item control, and/or a pause media item control), that, when selected, modify the playback status of the playback device. In some embodiments, while computer system 600 displays media playback user interface 618, computer system 600 transmits instructions to the playback device that cause the playback device to adjust the volume setting in response to computer system 600 detecting a rotation of rotatable input mechanism 616. In some embodiments, computer system 600 displays media playback user interface 618 with a dynamic background that is based on what media item the playback device is configured to playback and/or is playing back (e.g., the color of the background of media playback user interface 618 is based on what media item the playback device is configured to playback and/or is playing back or computer system 600 displays album art based on what media item the playback device is configured to playback and/or is playing back). In some embodiments, the amount of color and/or the color of the background changes as the volume level(s) of one or more of the playback device(s) is adjusted. In some embodiments, the amount of color and/or the color of the background is the median, mean, highest, and/or lowest volume level of a set of playback devices (and, in some embodiments, not all playback devices) that are in communication with computer system 600. In some embodiments, computer system 600 displays volume scale user interface object 622a as a continuous scale (e.g., volume scale user interface object 622a does not include discrete grid marks) and, in some embodiments, around at least a portion of rotatable input mechanism 616. In some embodiments, computer system 600 displays volume scale user interface object 622a as a non-continuous scale and, In some embodiments, around at least a portion of rotatable input mechanism 616.

At FIG. 2C, in response to detecting input 605b1, computer system 600 ceases to display media playback user interface 618 and computer system 600 displays temperature control user interface 628. As illustrated in FIG. 2C, temperature control user interface 628 includes temperature control user interface object 626, fan control user interface object 640, temperature scale user interface object 646a, temperature indicator user interface object 646b, and exit control user interface object 660. However, at FIG. 2C, computer system 600 does not continue to display volume scale user interface object 622a, volume level indicator user interface object 622b, and media item representation user interface object 624 because volume control user interface object 608 is not selected. Temperature control user interface object 626 and fan control user interface object 640 are sub controls of temperature control user interface object 612. Temperature control user interface object 626 corresponds to a temperature setting of the HVAC device and fan control user interface object 640 corresponds to a fan setting of the HVAC device.

Fan control user interface object 640 includes an indication of the current fan setting of the HVAC device. At FIG. 2C, as indicated by fan control user interface object 640, the HVAC device is set to a fan speed of 2. Similarly, temperature indicator user interface object 646b indicates the current temperature setting of the HVAC device. At FIG. 2C, as indicated by temperature indicator user interface object 646b, the HVAC device is set to a temperature setting of 70 degrees. Temperature scale user interface object 646a represents the range of temperature settings of the HVAC device. The leftmost portion of temperature scale user interface object 646a corresponds to the minimum temperature setting of the HVAC device and the rightmost portion of temperature scale user interface object 646a corresponds to the maximum temperature setting of the HVAC device. Thus, in some embodiments, computer system 600 displays one or more sub controls that corresponds to settings that have one or more sub controls and computer system 600 does not display one or more sub controls for settings that do not have sub controls. In some embodiments, a scale to control the one or more sub controls and/or a setting for the main control is displayed around rotatable input mechanism 616 while the user interface objects for the sub controls are concurrently displayed. In some embodiments, computer system 600 ceases to display temperature control user interface 628 and displays light control user interface object 606 in response to detecting an input that corresponds to selection of exit control user interface object 660. In some embodiments, computer system 600 displays a color gradient that is representative of various temperature settings within temperature scale user interface object 646a (e.g., the leftmost end of the color gradient is blue to represent the minimal temperature setting and the rightmost end of the color gradient is red to represent the maximum temperature setting). In some embodiments, temperature control user interface 628 does not include temperature scale user interface object 646a. In some embodiments, computer system 600 displays temperature scale user interface object 646a as a non-continuous scale (e.g., temperature scale user interface object 646a includes grid marks that each correspond to a respective temperature setting of the HVAC device) and, in some of these examples, around rotatable input mechanism 616). In some embodiments, computer system 600 displays temperature scale user interface object 646a as a continuous scale (and, in some of these examples, around rotatable input mechanism 616).

At FIG. 2C, temperature control user interface 628 does not include temperature control user interface object 612, light control user interface object 606, volume control user interface object 608, and blind control user interface object 610. Notably, in response to detecting input 605b1, computer system 600 ceases to display of light control user interface object 606, volume control user interface object 608, blind control user interface object 610 as a part of displaying temperature control user interface 628. Thus, in some embodiments, one or more main controls (e.g., light control user interface object 606, volume control user interface object 608, and/or blind control user interface object 610) cease to be displayed when one or more sub controls that corresponds to a main control is displayed with one or more main controls in response to a main control that does not have one or mor sub controls (e.g., greater than a threshold number of sub controls) being selected controls (e.g., as illustrated when comparing FIGS. 2A-2C).

In some embodiments, temperature control user interface 628 includes one or more of light control user interface object 606, volume control user interface object 608, blind control user interface object 610, and/or temperature control user interface object 612. In some embodiments, computer system 600 transmits instructions to the HVAC device that cause the temperature setting of the HVAC device to adjust in response to detecting a rotation of rotatable input mechanism 616 while computer system 600 displays temperature control user interface 628. At FIG. 2C, computer system 600 detects input 605c that corresponds to selection of fan control user interface object 640. In some embodiments, input 605c corresponds to a tap input, a long press (e.g., a tap and hold), a swipe input, a gaze, a voice command, a gaze, a depression of rotatable input mechanism 616, a rotation of rotatable input mechanism 616, and/or a hand gesture.

At FIG. 2D, in response to detecting input 605c, computer system 600 displays fan control user interface 630 and ceases to display temperature control user interface 628. As illustrated in FIG. 2D, fan control user interface 630 includes temperature control user interface object 626, fan control user interface object 640, fan scale user interface object 642, and exit control user interface object 660. Fan scale user interface object 642 indicates the current fan speed of the HVAC device. Fan scale user interface object 642 indicates the operation speed of the fan. For example, the fan of the HVAC device can operate at a speed ranging from a speed value of zero to a speed value of eight. When the fan of the HVAC device is operating at a speed value of zero, the fan of the HVAC device is not moving. In contrast, when the fan of the HVAC device is operating at a speed value of eight, the fan of the HVAC device is moving at a maximum speed. Computer system 600 displays a portion of fan scale user interface object 642 as filled in (e.g., shaded in) based on the current fan speed setting of the HVAC device (e.g., if the HVAC device is operating at a 50% fan speed (e.g., fan speed of 4), computer system 600 displays fan scale user interface object 642 as halfway filled in). At FIG. 2D, computer system 600 display a quarter of fan scale user interface object 642 as filled in. Accordingly, at FIG. 2D, the fan speed of the HVAC device is set to 25% power (e.g., fan speed of 2. In some embodiments, computer system 600 displays temperature scale user interface object 646a, volume scale user interface object 622a, sound scale user interface object 642, and fan scale user interface object 642 as different sizes based on the corresponding device of each respective scale user interface object. In some embodiments, computer system 600 displays temperature scale user interface object 646a, volume scale user interface object 622a, sound scale user interface object 642, and fan scale user interface object 642 with different colors based on which device each respective scale user interface object corresponds to. In some embodiments, computer system 600 displays each of temperature scale user interface object 646a, volume scale user interface object 622a, sound scale user interface object 642, and fan scale user interface object 642 around rotatable input mechanism 616. In some embodiments, computer system 600 displays a subset of temperature scale user interface object 646a, volume scale user interface object 622a, sound scale user interface object 642, and fan scale user interface object 642 around rotatable input mechanism 616. In some embodiments, computer system 600 displays sound scale user interface object 642, volume scale user interface object 622, fan scale user interface object 642, and temperature scale user interface object 646a at the same location on display 604.

As illustrated in FIG. 2D, computer system 600 displays fan control user interface 630 with dynamic background 632 (e.g., dynamic background 632 is represented by the diagonal lines on fan control user interface 630). At FIG. 2D, a determination is made that the temperature setting of the HVAC device is set to seventy degrees. Because a determination is made that the temperature setting of the HVAC device is set to seventy degrees, computer system 600 displays dynamic background 632 with a first appearance. Computer system 600 displays dynamic background 632 with one or more visual characteristics (e.g., size, hue, intensity of color, density of shading, and/or shade of color) that correspond to the temperature setting of the HVAC device. Computer system 600 changes the appearance of dynamic background 632 based on changes to the temperature setting of the HVAC device. Computer system 600 does not change the appearance of dynamic background 632 based on changes to the fan speed setting of the HVAC device. Thus, in some embodiments, computer system 600 displays the background to represent a setting corresponding to a sub control (e.g., temperature) while displaying a scale for controlling a setting of another sub control. In some embodiments, computer system 600 provides feedback to a user concerning a setting corresponding to a sub control that is not in focus for a particular user interface to quickly remind a user about the current setting for the sub control that is not in focus. In some embodiments, a not in focus sub control is a sub control for which a user interface object for controlling a setting is not currently displayed. For example, in FIG. 2D, dynamic background 632 alerts the user to the current temperature setting without the temperature scale user interface object 646a being in focus or displayed on the user interface at FIG. 2D. In some embodiments, computer system 600 updates dynamic background 632 in real-time based on changes to the temperature setting of the HVAC device, such as (1) changes made via computer system 600 and/or an input device in communication with computer system 600 (e.g., by navigating to another user interface to change the temperature setting and navigating back to where dynamic background 632 is displayed), (2) changes made via another computer system (e.g., different from computer system 600) in communication with computer system 600 and/or (3) changes made as a result of changes in temperature of an environment. In some embodiments, computer system 600 changes two or more visual characteristics of dynamic background 632 based on changes to the temperature setting of the HVAC device. In some embodiments, the changes to dynamic background 632 and the changes to the temperature setting of the HVAC device have an inverse relationship (e.g., as the temperature setting of the HVAC device increases, the size of dynamic background 632 decreases). In some embodiments, the changes to dynamic background 632 and the changes to the temperature setting of the HVAC device have a direct relationship (e.g., as the temperature setting of the HVAC device increases, the size of dynamic background 632 increases). In some embodiments, computer system 600 automatically (e.g., without intervening user input) updates the display of dynamic background 632 based on changes to environmental conditions within the external structure (e.g., ambient temperature, noise, brightness, and/or pollution level). In some embodiments, computer system 600 does not automatically update the display of dynamic background 632 based on changes to environmental conditions within the external structure.

At FIG. 2D, computer system 600 detects input 605d that corresponds to a clockwise rotation input on fan scale user interface object 642. In some embodiments, input 605d corresponds to a tap input, a long press (e.g., a tap and hold), a swipe input, a gaze, a voice command, a gaze, a depression of rotatable input mechanism 616, a rotation of rotatable input mechanism 616, and/or a hand gesture. In some embodiments, in response to detecting an input directed to fan scale user interface object 642 and/or on fan scale user interface object 642, computer system 600 performs one or more operations described in response to detecting input 605d.

At FIG. 2E, in response to detecting input 605d, computer system 600 transmits instructions to the HVAC device that cause the fan speed of the HVAC device to increase from 25% maximum speed to 50% maximum speed. Because the fan speed of the HVAC device is at 50% maximum speed, as illustrated in FIG. 2E, computer system 600 displays fan scale user interface object 642 as halfway filled. Computer system 600 does not modify the appearance of dynamic background 632 based on changes to the fan speed of the HVAC device. Accordingly, as illustrated in FIG. 2E, computer system 600 continues to display dynamic background 632 with the first appearance even though the fan speed setting of the HVAC device changes. In some embodiments, computer system 600 continues to display dynamic background 632 with the first appearance even though the fan speed setting of the HVAC device changes, because dynamic background 632 corresponds to the temperature setting of the HVAC device and not the fan speed setting of the HVAC device (e.g., as described above).

At FIG. 2E, in response to detecting input 605d, computer system 600 updates the display of fan control user interface object 640 such that fan control user interface object 640 indicates that the fan speed setting of the HVAC device is set to 4 (e.g., 50% fan speed). In some embodiments, while computer system 600 displays fan control user interface 630, computer system 600 transmits instructions to the HVAC device that cause the HVAC device to increase its fan speed in response to computer system 600 detecting that rotatable input mechanism 616 is rotated in a clockwise direction. In some embodiments, computer system 600 transmits instructions to the HVAC device that cause the HVAC device to decrease its fan speed in response to computer system 600 detecting that rotatable input mechanism 616 is rotated in a counterclockwise direction. In some embodiments, computer system 600 changes the appearance (e.g., color and/or size) of fan scale user interface object 642 and/or fan control user interface object 640 based on changes to the fan speed setting of the HVAC device and/or in response to detecting input 605d. At FIG. 2E, computer system 600 detects input 605e that corresponds to selection of temperature control user interface object 626. In some embodiments, input 605e corresponds to a tap input, a long press (e.g., a tap and hold), a swipe input, a gaze, a voice command, a gaze, a depression of rotatable input mechanism 616, a rotation of rotatable input mechanism 616, and/or a hand gesture. In some embodiments, computer system 600 updates the display of fan control user interface object 640 such that fan control user interface object 640 indicates that the fan speed setting of the HVAC device is set to 4 when a determination is made that the fan HVAC device is operating at a fan speed of 4.

At FIG. 2F, in response to detecting input 605e, computer system 600 displays temperature control user interface 628 and ceases to display fan control user interface 630. Temperature control user interface 628 does not include a dynamic background that changes based on changes to the operation of the HVAC device. At FIG. 2F, computer system 600 displays temperature control user interface 628 with the same appearance that temperature control user interface has at FIG. 2C. Notably, by displaying temperature control user interface 628 with the same appearance and/or without changing the background, computer system 600 does not indicate that the fan speed changed (e.g., as described above in relation to FIGS. 2D-2E). In some embodiments, computer system 600 does not change the background of a user interface to indicate that settings corresponding to certain sub controls while computer system 600 does change the background of another respective user interface to indicate that settings corresponding to other sub controls have changed. Thus, in some embodiments, computer system 600 allows different settings to impact backgrounds of respective user interfaces differently. At FIG. 2F, computer system 600 detects input 605f that corresponds to a rightward swipe input on temperature indicator user interface object 646b. In some embodiments, input 605f corresponds to a tap input, a long press (e.g., a tap and hold), a swipe input, a gaze, a voice command, a gaze, a depression of rotatable input mechanism 616, a rotation of rotatable input mechanism 616, and/or a hand gesture.

At FIG. 2G, in response to detecting input 605f, computer system 600 transmits instructions to the HVAC device that cause the temperature setting of the HVAC device to increase to from 70 degrees to 75 degrees. Accordingly, as illustrated in FIG. 2G, computer system 600 displays temperature control user interface object 626 with an indication that the temperature setting of the HVAC device is set to 75 degrees. At FIG. 2G, because the temperature of the HVAC device increases, computer system 600 moves the display of temperature indication user interface object 646b to the right on temperature scale user interface object 646a (e.g., in contrast to the display of temperature indication user interface object 646b at FIG. 2F).

As described above, computer system 600 does not change the background of temperature control user interface 628 based on changes to the temperature setting (e.g., temperature sub control and/or temperature scale user interface object 646a) for the HVAC device. Accordingly, at FIG. 2G, computer system 600 displays temperature control user interface 628 with the same appearance that temperature control user interface has at FIGS. 2C and 2F. In some embodiments, while computer system 600 displays temperature control user interface 628, computer system 600 transmits instructions to the HVAC device that increase the temperature setting of the HVAC device in response to computer system 600 detecting that rotatable input mechanism 616 is rotated in a clockwise direction. In some embodiments, while computer system 600 displays temperature control user interface 628, computer system 600 transmits instructions to the HVAC device that cause the temperature setting of the HVAC device to decrease in response to computer system 600 detecting that rotatable input mechanism 616 is rotated in a counterclockwise direction. In some embodiments, computer system 600 changes the appearance (e.g., color and/or size) of temperature scale user interface object 646a and/or the temperature control user interface object 626 based on changes to the temperature setting of the HVAC device. At FIG. 2G, computer system 600 detects input 605g that corresponds to selection of fan control user interface object 640.

At FIG. 2H, in response to detecting input 605g, computer system 600 ceases to display temperature control user interface 628 and displays fan control user interface 630. At FIG. 2H, a determination is made that the temperature setting of the HVAC device is set to 75 degrees. Because a determination is made that the temperature setting of the HVAC device is set to 75 degrees, computer system 600 displays dynamic background 632 with a second appearance (e.g., that is different than the first appearance of dynamic background 632 at FIGS. 2D and 2E) (e.g., illustrated by difference in hatching when comparing FIGS. 2D and 2E to FIG. 2H). As described above, the appearance of dynamic background 632 is based on the temperature setting of the HVAC device. Accordingly, as the temperature setting of the HVAC device changes, the appearance of dynamic background 632 also changes. In some embodiments, in response to detecting selection of exit control user interface object 660 after either the fan setting and/or the temperature setting of the HVAC device is changed, computer system 600 displays light control user interface 602. In some embodiments, as part of displaying light control user interface 602, computer system 600 animates the display of temperature control user interface object 612. In some embodiments, where computer system 600 animates the display temperature control user interface object 612, computer system 600 animates the display of temperature control user interface object 612 in a first manner if the temperature setting (e.g., and not the fan setting) of the HVAC device is changed and computer system 600 animates the display of temperature control user interface object in a second manner if the fan setting (e.g., and not the temperature setting) of the HVAC device is changed. In some embodiments, where computer system 600 animates the display temperature control user interface object 612 as part of displaying light control user interface 602, computer system 600 does not animate the display of light control user interface object 606, volume control user interface object 608, and/or blind control user interface object 610. Turning back to FIG. 2B, computer system 600 detects input 605b2 that corresponds to selection of blind control user interface object 610.

At FIG. 2I, in response to detecting input 605b2 at FIG. 2B, computer system 600 displays blind control user interface 648. As illustrated in FIG. 2I, blind control user interface object 648 includes first window control user interface object 652, second window control user interface object 654, tint control user interface object 656, exit control user interface object 660 and window scale user interface object 658. First window control user interface object 652 corresponds to (e.g., is configured to control) a first window that is in a first area of the external structure and second window control user interface object 654 corresponds (e.g., is configured to control) to a second window that is in a second area of the external structure. Window scale user interface object 658 provides status information regarding a window that computer system 600 is presently targeting (e.g., is presently configured to control and/or is presently configured to cause the target window to perform an operation). Each of first window control user interface object 652, second window control user interface object 654, tint control user interface object 656 and window scale user interface object 658 are sub controls of blind control user interface object 610. Both first window control user interface object 652 and second window control user interface objects are local controls. Local controls are controls that, when selected, cause the state of a first respective device (e.g., a window) to be adjusted without causing the state of a second respective device to be adjusted.

At FIG. 2I, a determination is made that the user is positioned in the first area of the external structure. Because a determination is made that the user is positioned in the first area of the external structure, computer system 600 displays first window control user interface object 652 as visually emphasized (e.g., computer system 600 displays first window control user interface object 652 as highlighted and computer system 600 does not display second window control user interface object 654 as highlighted). Computer system 600 selectively emphasizes first window control user interface object 652 or second window control user interface object 654 based on the positioning of the user within the external structure.

Computer system 600 targets the first window while computer system 600 displays first window control user interface object 652 as visually emphasized. Accordingly, at FIG. 2I, the status information included in window scale user interface object 658 corresponds to the first window. In some embodiments, while computer system 600 targets the first window and in response to detecting input 605i2 directed at tint control user interface object 656, computer system 600 displays a tint scale user interface object that indicates the current tint level of the first window. In some embodiments, while computer system 600 displays the tint scale user interface object that indicates the tint level of the first window and in response to detecting an input that corresponds to the tint scale user interface object, computer system 600 transmits instructions to the first window that cause the first window to modify the tint level of the second window. In some embodiments, computer system 600 displays window scale user interface object 658 around rotatable input mechanism 616. In some embodiments, computer system 600 displays tint control user interface object 656 and window scale user interface object 658 in response to detecting an input directed at first window control user interface object 652. In some embodiments, computer system 600 ceases to display blind control user interface 648 in response to detecting an input that corresponds to selection of exit control user interface object 660.

At FIG. 2I, because a determination is made that the user is positioned in the first area of the external structure, computer system 600 configures rotatable input mechanism 616 to control the first window. In some embodiments, computer system 600 ceases to display first window control user interface object 652 as visually emphasized and displays second window control user interface object 654 as visually emphasized because a determination is made that the user has moved from the first area of the external structure to the second area of the external structure. In some embodiments, if a determination is made that the user is positioned in the second area of the external structure, computer system 600 configures rotatable input mechanism 616 to control the second window, where the second area is closer to the second window than the first window. In some embodiments, the first area is closer to the first window than the second window. In some embodiments, while rotatable input mechanism 616 is configured to control the first window, computer system 600 transmits instructions to the first window that cause the first window to adjust its operation state in response to detecting an input directed at rotatable input mechanism 616. In some embodiments, computer system 600 displays blind control user interface 648 in response to detecting an input that corresponds to blind control user interface object 610 while computer system 600 displays light control user interface 602. At FIG. 2I, computer system 600 detects input 605i1 that corresponds to selection of second window control user interface object 654. In some embodiments, input 605i1 corresponds to a tap input, a long press (e.g., a tap and hold), a swipe input, a gaze, a voice command, a gaze, a depression of rotatable input mechanism 616, a rotation of rotatable input mechanism 616, and/or a hand gesture.

As illustrated in FIG. 2J, in response to detecting input 605i1, computer system 600 continues to display first window control user interface object 652, second window control user interface object 654, tint control user interface object 656, and window scale user interface object 658. Further, at FIG. 2J, in response to detecting input 605i1, computer system 600 deemphasizes first window control user interface object 652 and visually emphasizes second window control user interface object 654. At FIG. 2J, in response to detecting input 605i1, computer system 600 switches from targeting the first window to targeting the second window. Computer system 600 displays second window control user interface object 654 as visually emphasized to indicate that computer system 600 is currently targeting the second window. As described above, the information included in window scale user interface object 658 corresponds to the window that computer system 600 targets. Accordingly, at FIG. 2J, the information included in window scale user interface object 658 corresponds to the second window. At FIG. 2J, as part of displaying window scale user interface object 658, computer system 600 updates the display of window scale user interface object 658 such that the information included in window scale user interface object 658 corresponds to the second window in the external structure and not the first window. Accordingly, at FIG. 2J, the second window is 80% closed.

At FIG. 2J, in response to detecting input 605i1, computer system 600 de-configures rotatable input mechanism 616 from controlling the first window and computer system 600 configures rotatable input mechanism 616 to control the second window. In some embodiments, while the second window is targeted, computer system 600 displays a tint scale user interface object that indicates the tint level of the second window in response to detecting input 605j that corresponds to selection of tint control user interface object 656. In some embodiments, while computer system 600 displays the tint scale user interface object that corresponds to the second window, in response to detecting an input that corresponds to the tint scale user interface object, computer system 600 transmits instructions to the second window that cause the second window to modify the tint level of the second window. In some embodiments, although tint control user interface object 656 is a sub control, one or more backgrounds of one or more user interfaces are not modified due to the changing of the tint of a window. In some embodiments, one or more backgrounds of one or more user interfaces are not modified due to the changing of the tint of a window because a determination is made that the tint for individual windows do not have a threshold level of relatedness (e.g., as opposed to the temperature and fan sub controls described above in relation to FIGS. 2C-2H).

FIGS. 3A-3C are a flow diagram illustrating a method (e.g., process 700) for displaying different controls in accordance with some examples. Some operations in process 700 are, optionally, combined, the orders of some operations are, optionally, changed, and some operations are, optionally, omitted.

As described below, process 700 provides an intuitive way for displaying different controls. Process 700 reduces the cognitive burden on a user for displaying different controls, thereby creating a more efficient human-machine interface. For battery-operated computing devices, enabling a user to display different controls faster and more efficiently conserves power and increases the time between battery charges.

In some embodiments, process 700 is performed at a computer system (e.g., 600) that is in communication with a display component (e.g., 604) (e.g., a display screen and/or a touch-sensitive display). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

The computer system displays (702), via the display component (e.g., 604): a plurality of controls (704) (e.g., 606, 608, 610, and/or 612) that includes a first control (e.g., 606, 608, 610, and/or 612); and a representation of a scale (706) (e.g., 614, 622, 662, 646a) at a respective position and with a first visual appearance (e.g., a size, color, width, height, pattern, and/or shape). In some embodiments, a respective control of the plurality of controls corresponds to a respective device in communication with the computer system. In some embodiments, the respective control of the plurality of controls is configured to, in response to input, (1) modify a setting and/or value corresponding to the respective device and/or (2) cause display of one or more controls to be used to modify setting and/or value corresponding to the respective device. In some embodiments, the first visual appearance does not relate to a position of the representation of the scale. In some embodiments, the scale at least partially circumscribes the first control and/or the plurality of controls. In some embodiments, the scale with the first visual appearance indicates a current value for a setting, such as a setting for a device corresponding to a second control of the plurality of control different from the first control. In some embodiments, the first visual appearance does not relate to and/or indicate the current value. In some embodiments, the first visual appearance indicates a range and/or possible values of the scale.

While displaying the plurality of controls (e.g., 606, 608, 610, and/or 612) that includes the first control (e.g., 606, 608, 610, and/or 612) and the representation of the scale (e.g., 614, 622, 662, 646a) at the respective position and with the first visual appearance, the computer system detects (708) an input (e.g., 605a, 605b1, 605b2, 605c, 605e, and/or 605g) (e.g., a tap input and/or a non-tap input (e.g., a gaze input, an air gesture, a pointing gesture a swipe input, and/or a mouse click)) directed to the first control.

In response to (710) detecting the input (e.g., 605a, 605b1, 605b2, 605c, 605e, and/or 605g) directed to the first control (e.g., 606, 608, 610, and/or 612) and in accordance with a determination that the first control (e.g., 606, 608, 610, and/or 612) is a first type of control (e.g., a control configured to modify a setting or value), the computer system displays (712), via the display component (e.g., 604), the representation of the scale (e.g., 614, 622, 662, 646a) with a second visual appearance (e.g., changing a size, color, width, height, pattern, and/or shape) that is different from the first visual appearance while continuing to display the representation of the scale at the respective location and the plurality of controls (e.g., 606, 608, 610, and/or 612) (e.g., as described above at FIG. 2B).

In response to (710) detecting the input directed to the first control and in accordance with (714) a determination that the first control (e.g., 606, 608, 610, and/or 612) is a second type of control (e.g., a control configured to display one or more other controls) that is different from the first type of control, the computer system displays (716), via the display component (e.g., 604), the representation of the scale (e.g., 614, 622, 662, 646a) with a third visual appearance (e.g., changing a size, color, width, height, pattern, and/or shape, such as to correspond to a control different from the first control) that is different from the first visual appearance (and, in some embodiments, that is different from the first visual appearance) while continuing to display the representation of the scale at the respective location (e.g., as described above at FIG. 2C). In some embodiments, the scale with the second visual appearance indicates a current value for a setting, such as a setting for a device corresponding to the first control.

In response to (710) detecting the input directed to the first control and in accordance with (714) the determination that the first control is the second type of control that is different from the first type of control, the computer system ceases (718) to display at least one control of the plurality of controls (e.g., 606, 608, 610, and/or 612) (e.g., as described above at FIG. 2C). In some embodiments, in response to detecting the input directed to the first control and in accordance with a determination that the first control is the second type of control, the computer system ceases to display the plurality of controls (e.g., all of and/or more of the plurality of controls and/or, in some embodiments, including the first control). In some embodiments, in response to detecting the input directed to the first control and in accordance with a determination that the first control is the second type of control, the computer system continues to display the first control but not a second control of the plurality of controls. In such examples, the computer system continues to display the first control c in the same position or moves display of the first control to a different position. Displaying the representation of the scale with different visual appearances based on the type of control to which an input was directed allows the computer system to automatically display different control options when a set of prescribed conditions are met and provides the user with more control over the computer system to change various settings, thereby performing an operation when a set of conditions has been met without requiring further user input and providing the user with additional control options without cluttering the user interface. Displaying the at least one control of the plurality of controls in response to detecting the input when prescribed conditions are met allows the computer system to continue displaying quick access to other controls when selecting the first type of control while not continuing to display quick access to other controls when selecting the second type of control (and optionally provide additional display area where the at least one control was previously displayed), thereby performing an operation when a set of conditions has been met without requiring further user input and providing the user with additional control options without cluttering the user interface.

In some embodiments, the computer system (e.g., 600) is in communication with a first physical input mechanism (e.g., 616) (e.g., a hardware input mechanism, a rotatable input mechanism, a crown, a knob, a dial, a physical slider, and/or a hardware button). In some embodiments, while displaying the representation of the scale (e.g., 614, 622, 662, 646a), the computer system detects an input (e.g., 605d) (e.g., a tap input and/or a non-tap input (e.g., a gaze input, an air gesture, a pointing gesture a swipe input, and/or a mouse click)) directed to the first physical input mechanism. In some embodiments, in response to detecting the input directed to the first physical input mechanism, the computer system changes a respective value of a respective setting (e.g., as described above at FIG. 2E). In some embodiments, in response to detecting the input directed to the physical input mechanism while the representation of the scale is displayed with the second visual appearance, the respective setting is a first type of setting (e.g., a setting that causes output of a first type of device to change and/or that corresponds to the first type of control); in response to detecting the input directed to the physical input mechanism while the representation of the scale is displayed with the third visual appearance, the respective setting is a second type of setting (e.g., a setting that causes output of a second type of device to change and/or that corresponds to the second type of control), where the first type of setting is different from the second type of setting and the second type of device is different from the first type of device; and in response to detecting input directed to the physical input mechanism while the representation of the scale is displayed with the first visual appearance, the respective setting a third type of setting (e.g., a setting that causes output of a third type of device to change and/or that corresponds to a third type of control), where the third type of setting is different from the first type of setting and the second type of setting and the third type of device is different from the first type of device and the second type of device. In some embodiments, in response to detecting input directed to the physical input mechanism in a first direction and/or with a first speed, the respective value is a first respective value; and in response to detecting input detecting input directed to the physical input mechanism in a second direction different from the first direction and/or with a second speed different from the first speed. Changing a respective value of a respective setting in response to detecting the input directed to the first physical input mechanism provides the user with control over the user interface to change the respective value of the respective setting, thereby providing the user with additional control options without cluttering the user interface. Providing two separate input mechanisms (e.g., input directed to a control and input directed to the first physical input mechanism) for performing different operations allows for the computer system to display less and still maintain a higher number of interaction possibilities, thereby providing the user with additional control options without cluttering the user interface.

In some embodiments, in response to detecting the input (e.g., 605e) directed to the first physical input mechanism (e.g., 616) and in accordance with a determination that the changed respective value is a first value, the computer system changes, via the display component (e.g., 604), a visual appearance of the first control (e.g., 606, 608, 610, and/or 612) in a first manner (e.g., increasing and/or decreasing the amount of a visual characteristic (e.g., color, hue, intensity, tone, size, and/or tint) and/or including and/or removing a graphical representation from the control) (e.g., as described above at FIG. 2E). In some embodiments, in response to detecting the input directed to the first physical input mechanism and in accordance with a determination that the changed respective value is a second value different from the first value, the computer system changes, via the display component, the visual appearance of the first control in a second manner (e.g., increasing and/or decreasing the amount of a visual characteristic (e.g., color, hue, intensity, tone, size, and/or tint) and/or including and/or removing a graphical representation from the control) that is different from the first manner (e.g., as described above at FIG. 2E). In some embodiments, the visual appearance of the first control changed in the first manner is visually different from the visual appearance of the first control changed in the second manner. Changing the visual appearance of the first control in different manners based on the difference between the changed respective value and the first value allows the computer system to automatically display different indications of the relationship between the changed respective value and the first value and provides the user with control over the user interface to change the respective value of the respective setting, thereby performing an operation when a set of conditions has been met without requiring further user input and providing the user with additional control options without cluttering the user interface.

In some embodiments, in response to detecting the input (e.g., 605a, 605b1, 605b2, 605c, 605e, and/or 605g) directed to the first control (e.g., 606, 608, 610, and/or 612) and in accordance with a determination that the first control is the second type of control, the computer system displays, via the display component (e.g., 604), a second control (e.g., 606, 608, 610, and/or 612) (e.g., one sub controls, a control that is related to one or more sub controls, and/or one controls that were not previously displayed) and a third control (e.g., 606, 608, 610, and/or 612). In some embodiments, while displaying the second control and the third control, the computer system detects a respective input (, 605e, and/or 605g) (e.g., a tap input and/or a non-tap input (e.g., a gaze input, an air gesture, a pointing gesture a swipe input, and/or a mouse click)). In some embodiments, in response to detecting the respective input and in accordance with a determination that the respective input is directed to the second control, the computer system causes the computer system (e.g., 600) to be configured to cause a first property (e.g., air speed, openness, heat, cooling, sound, bass, high range sound, low range sound, and/or midrange sound) of output of a first device to change. In some embodiments, in response to detecting the respective input and in accordance with the determination that the respective input is directed to the second control, the computer system causes the computer system to be configured to cause a first property to change. In some embodiments, the first property corresponds to a first setting. In some embodiments, the first property corresponds to the first device. In some embodiments, in response to detecting the respective input and in accordance with a determination that the respective input is directed to the third control, the computer system causes the computer system to be configured to cause a second property (e.g., air speed, openness, heat, cooling, sound, bass, high range sound, low range sound, and/or midrange sound) of output of the first device to change (e.g., without causing the first property of output to change), wherein the second property is different from the first property (e.g., as described above at FIG. 2F). In some embodiments, causing the computer system to be configured to change a respective property of output of a device to change includes causing the respective property of output of the device to change. In some embodiments, causing the computer system to be configured to change a respective property of output of a device to change includes displaying a control that, when selected, causes the respective property of output of the device to change. In some embodiments, in response to detecting the input directed to the second control, the computer system displays, via the display component, the representation of the scale with a fourth visual appearance that is different from the third visual appearance (and/or the second visual appearance and/or the first visual appearance). In some embodiments, in response to detecting the respective input and in accordance with the determination that the respective input is directed to the third control, the computer system causes the computer system to be configured to cause a second property to change, wherein the second property is different from the first property. In some embodiments, the second property corresponds to the first setting. In some embodiments, the second property corresponds to a second device different from the first device. Causing the computer system to cause different properties of the first device to change based on the input being directed to a particular control allows the computer system to automatically perform different operations based on the input that is detected and provides the user with control over the user interface to change a respective property of output of the first device, thereby performing an operation when a set of conditions has been met without requiring further user input and providing the user with additional control options without cluttering the user interface.

In some embodiments, in response to detecting the input (e.g., 605a, 605b1, 605b2, 605c, 605e, and/or 605g) directed to the first control (e.g., 606, 608, 610, and/or 612) and in accordance with a determination that the first control is the second type of control, the computer system forgoes displaying, via the display component (e.g., 604), the second control and the third control (e.g., as described above at FIG. 2B) (and/or forgoing display one or more other sub controls). Forgoing displaying the second control and the third control in response to detecting the input directed to the first control and in accordance with a determination that the first control is the second type of control allows the computer system to not display sub-controls (e.g., the second control and the third control) for a primary control (e.g., the first control) that does not have the sub controls, thereby performing an operation when a set of conditions has been met without requiring further user input.

In some embodiments, in response to detecting the respective input (e.g., 605a, 605b1, 605b2, 605c, 605e, and/or 605g) and in accordance with a determination that the respective input is directed to the second control and the second control (e.g., 606, 608, 610, and/or 612) is a third type of control, the computer system displays, via the display component (e.g., 604), the representation of the scale (e.g., 614, 622, 662, 646a) (e.g., and/or continuing to display the representation of the scale) (e.g., while continuing to display the second control and/or a control that was previously displayed). In some embodiments, in response to detecting the respective input and in accordance with a determination that the respective input is directed to the second control and the second control is a fourth type of control that is different from the third type of control, the computer system forgoes displaying, via the display component, the representation of the scale (e.g., while continuing to display the second control and/or a control that was previously displayed). Choosing whether to display the scale or not display the scale based on the input being directed to a particular control allows the computer system to automatically display the scale in some situations and to not automatically display the scale in other situations in order to manage screen real estate and provides the user with control over the user interface to selectively display the scale, thereby performing an operation when a set of conditions has been met without requiring further user input and providing the user with additional control options without cluttering the user interface.

In some embodiments, in response to detecting the input (e.g., 605a, 605b1, 605b2, 605c, 605e, and/or 605g) directed to the first control (e.g., 606, 608, 610, and/or 612) and in accordance with a determination that the first control is the second type of control, the computer system displays, via the display component (e.g., 604), a fourth control (e.g., 606, 608, 610,612, 652 and/or 654) (e.g., one sub controls, a control that is related to one or more sub controls, and/or one controls that were not previously displayed) and a fifth control (e.g., 606, 608, 610,612, 652 and/or 654), wherein, in accordance with a determination that the second type of control corresponds to multiple device, selection of the fourth control configures the computer system (e.g., 600) to control a second device (e.g., as described above at FIG. 2I) and selection of the fifth control configures the computer system to control a third device that is different from the second device (e.g., without being configured to control the second device) (e.g., as described above at FIG. 2I) and in accordance with a determination that the second type of control does not correspond to multiple devices selection of the fourth control configures the computer system to control a first property of the first device (e.g., without controlling output and/or a property of the second device) (e.g., to control the output of the first device, such as the output of an actuator) (e.g., as described above at FIG. 2C) and selection of the fifth control configures the computer system to control a second property that is different from the first property, of the first device (e.g., as described above at FIG. 2C) (e.g., without controlling output of and/or a property of the second device). In some embodiments, the third device is the same type (e.g., window, a speaker, and/or a door) of device as the second device. In some embodiments, the third device is associated with a different location (e.g., left window, right window, front door, and/or back door) than the second device Having multiple controls that are selectable to control different device and/or the same device when prescribed conditions are met allows the computer system to automatically provide preferred controls in different situations in order to give the user the ability to control the computer system in ways that are consistent with a prescribed condition, thereby performing an operation when a set of conditions has been met without requiring further user input and providing the user with additional control options without cluttering the user interface.

In some embodiments, the computer system (e.g., 600) is in communication with a second physical input mechanism (e.g., 616). In some embodiments, the representation of the scale (e.g., 614, 622, 662, 646a) is displayed at least partially (or but not fully) (or, In some embodiments, fully) around the second physical input mechanism. Displaying the representation of the scale that partially surrounds a second physical input mechanism provides a user with a visual indication of how to use the physical input mechanism to control the computer system, thereby providing improved visual feedback.

In some embodiments, the representation of the scale (e.g., 614, 622, 662, 646a) displayed with the second visual appearance has a first size that is based on a set of one or more values corresponding to the first type of control (e.g., as described above at FIG. 2E). In some embodiments, the representation of the scale displayed with the third visual appearance has a second size that is based on a set of one or more values corresponding to the second type of control (e.g., as described above at FIG. 2E). In some embodiments, the second size is different from the first size. In some embodiments, displaying the representation of the scale with the second visual appearance includes changing (e.g., enlarged and/or compressing) the representation of the scale from a third size (e.g., while the representation of the scale was displayed with the first visual appearance) to the first size. In some embodiments, displaying the representation of the scale with the third visual appearance includes changing (e.g., enlarged and/or compressing) the representation of the scale from the third size to the second size. Displaying the representation of the scale with different sizes based on the type of control to which an input was directed allows the computer system to automatically display different control options when a set of prescribed conditions are met and provides the user with more control over the computer system to change various settings, thereby performing an operation when a set of conditions has been met without requiring further user input and providing the user with additional control options without cluttering the user interface.

In some embodiments, the representation of the scale (e.g., 614, 622, 662, 646a) displayed with the second visual appearance has a first color characteristic (e.g., a first hue, tint, shade, boldness, highlighting, and/or saturation). In some embodiments, the representation of the scale displayed with the third visual appearance has a second color characteristic (e.g., a first hue, tint, shade, boldness, highlighting, and/or saturation) that is different from the first color characteristic (e.g., as described above at FIG. 2D). In some embodiments, the first color characteristic corresponds to the first type of control. In some embodiments, the second color characteristic corresponds to the second type of control. In some embodiments, displaying the representation of the scale with the second visual appearance includes changing the representation of the scale from having a third color characteristic to having the first color characteristic. In some embodiments, displaying the representation of the scale with the third visual appearance includes changing (e.g., enlarged and/or compressing) the representation of the scale from having the third color characteristic to having the second color characteristic. Displaying the representation of the scale with different colors based on the type of control to which an input was directed allows the computer system to automatically display different control options when a set of prescribed conditions are met and provides the user with more control over the computer system to change various settings, thereby performing an operation when a set of conditions has been met without requiring further user input and providing the user with additional control options without cluttering the user interface.

In some embodiments, the representation of the first scale (e.g., 614, 622, 662, 646a) displayed with the second visual appearance includes a first number of segments (e.g., is made up of, is not displayed with more than, is displayed exactly with, and/or is displayed with the first number of segments) (e.g., separate, continuous, and/or non-continuous segments). In some embodiments, the representation of the first scale displayed with the third visual appearances includes a second number of segments (e.g., separate, continuous, and/or non-continuous segments) that is different from the first number of segments (e.g., as described above at FIG. 2B) (e.g., is made up of, is not displayed with more than, is displayed exactly with, and/or is displayed with the second number of segments). In some embodiments, the representation of the scale displayed with the first visual appearances includes a third number of segments that is different from the second number of segments and/or the first number of segments. In some embodiments, the representation of the scale is displayed to indicate continuous movement and/or non-continuous movement based on the type of control that the scale corresponds to at an instance in time. In some embodiments, the representation of the first scale displayed with the second visual appearance consists of the first number of segments. In some embodiments, the representation of the first scale displayed with the third visual appearance consists of the second number of segments. In some embodiments, the first number of segments is one. In some embodiments, the second number of segments is more than one. In some embodiments, the second visual appearance is a continuous appearance with no gaps and/or separations between adjacent segments of the representation of the first scale. In some embodiments, the third visual appearance is a non-continuous appearance with one or more gaps and/or separations between adjacent segments of the representation of the first scale. Displaying the representation of the scale with different numbers of segments based on the type of control to which an input was directed allows the computer system to automatically display different control options when a set of prescribed conditions are met and provides the user with more control over the computer system to change various settings, thereby performing an operation when a set of conditions has been met without requiring further user input and providing the user with additional control options without cluttering the user interface.

In some embodiments, the second physical input mechanism (e.g., 616) is a rotatable input mechanism.

In some embodiments, the first type of control is a global control (e.g., as described above at FIGS. 2A and 2B) (e.g., that, when selected, causes output of a first respective device and a second respective device to be adjusted). In some embodiments, the second type of control is a local control (e.g., that, when selected, causes output of the first respective device to be adjusted without causing the second respective device to be adjusted) (e.g., as described above at FIG. 2I).

In some embodiments, the computer system (e.g., 600) is in communication with a third physical input mechanism (e.g., 616). In some embodiments, in response to detecting the input (e.g., 605a, 605b1, 605b2, 605c, 605e, and/or 605g) directed to the first control (e.g., 606, 608, 610), and in accordance with a determination that the first control is a fifth type of control, the representation of the scale (e.g., 614, 622, 662, 646a) is displayed at least partially around the third physical input mechanism (e.g., as described above at FIG. 2D) and in accordance with a determination that the first control is a sixth type of control that is different from the fifth type of control, the representation of the scale is not displayed at least partially around the third physical input mechanism (e.g., as described above at FIG. 2D). Displaying or not displaying a representation around the physical input mechanism based on prescribed conditions allows the computer system to selectively provide feedback, which can inform the user how the physical input mechanism can be used to control a setting, thereby performing an operation when a set of conditions has been met without requiring further user input and providing improved visual feedback.

Note that details of the processes described above with respect to process 700 (e.g., FIG. 3) are also applicable in an analogous manner to other methods described herein. For example, process 800 optionally includes one or more of the characteristics of the various methods described above with reference to process 700. For example, the plurality of controls can be displayed using one or more techniques described above in relation to process 700, where the appearance of the plurality of controls can change based on a change to a value of a setting using one or more techniques described below in relation to process 800. For brevity, these details are not repeated below.

FIGS. 4A-4C are a flow diagram illustrating a method (e.g., process 800) for updating the background of a respective user interface in accordance with some examples. Some operations in process 800 are, optionally, combined, the orders of some operations are, optionally, changed, and some operations are, optionally, omitted.

As described below, process 800 provides an intuitive way for updating the background of a respective user interface. Process 800 reduces the cognitive burden on a user for updating the background of a respective user interface, thereby creating a more efficient human-machine interface. For battery-operated computing devices, enabling a user to update the background of a respective user interface faster and more efficiently conserves power and increases the time between battery charges.

In some embodiments, process 800 is performed at a computer system (e.g., 600) that is in communication with a display component (e.g., 604) (e.g., a display screen and/or a touch-sensitive display). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

The computer system displays (802), via the display component (e.g., 604), a first user interface (e.g., 602, 618, 628, and/or 648) (e.g., a user interface for the fan speed of a fan) that includes: a plurality of controls (804) (e.g., 606, 608, 610, 612, 626, 628, 652, and/or 654), including a first control (e.g., 606, 608, 610, 612, 626, 628, 652, and/or 654) (e.g., that, when selected, causes the computer system to display a user interface for adjusting output of a device in a first manner) (e.g., the first control is for fan speed of the fan) and a second control (e.g., 606, 608, 610, 612, 626, 628, 652, and/or 654) (e.g., that, when selected, causes the computer system to display a user interface for adjusting output of the device in a second manner that is different from the first manner) (e.g., the second control is for temperature); a representation (806) (e.g., one or more alphanumeric characters, a particular color and/or size of a user-interface object, and/or an indicator on a scale and/or slider) of a first value (e.g., 646b and/or 622b); and a first background (808) (e.g., 632) (e.g., a color and/or pattern that is visually behind at least a portion of the plurality of controls and/or the representation of the first value) that has a first visual appearance (e.g., a size, color, width, height, pattern, and/or shape) (e.g., without having the second visual appearance). In some embodiments, the first user interface includes an indication that the second control is selected. In some embodiments, the first value corresponds to the first control or the second control. In some embodiments, the first value corresponds to a setting of the device. In some embodiments, the first background corresponds to the first control.

While displaying the first user interface (e.g., 602, 618, 628, and/or 648) that includes the plurality of the controls (e.g., 606, 608, 610, 612, 626, 628, 652, and/or 654), the representation of the first value (e.g., 646b and/or 622b), and the first background (e.g., 632) that has the first visual appearance, the computer system detects (810) an input (e.g., 605e) (e.g., a tap input and/or a non-tap input (e.g., a gaze input, an air gesture, a pointing gesture a swipe input, and/or a mouse click)) (e.g., a first type of input) directed to the first control (e.g., 606, 608, 610, 612, 626, 628, 652, and/or 654). In some embodiments, the input directed to the first control is a request to view information related to the first control and/or modify one or more values and/or settings corresponding to the first control.

In response to (812) detecting the input directed to the first control (e.g., 606, 608, 610, 612, 626, 628, 652, and/or 654), the computer system displays (814), via the display component (e.g., 604), a second user interface (e.g., 602, 618, 628, and/or 648) (e.g., different from the first user interface) that includes: the plurality of controls (816) (e.g., 606, 608, 610, 612, 626, 628, 652, and/or 654) (e.g., including the first control and the second control); a representation (e.g., one or more alphanumeric characters, a particular color and/or size of a user-interface object, and/or an indicator on a scale and/or slider) of a second value (818) (e.g., 646b and/or 622b) that is different from the representation of the first value (e.g., 646b and/or 622b) (e.g., the second value is different from the first value); and a second background (820) (e.g., 632) that has a second visual appearance without having the first visual appearance. In some embodiments, the second user interface includes an indication that the first control is selected. In some embodiments, the representation of the second value is different from the representation of the first value due to the values being different. In some embodiments, how the first value and the second value are being represented are the same and the difference in value is what makes the representations different. In some embodiments, the second value corresponds to the first control and not the second control while the first value corresponds to the second control and not the first control. In some embodiments, the second background is the same size, shape, height, and/or width of the first background but the second background has a different color and/or pattern than the first background. In some embodiments, the second background does not correspond to a control of the plurality of controls. In some embodiments, the second background is blank. In some embodiments, the second background corresponds to the second control. In some embodiments, the second background does not indicate information and/or data related to a respective control (e.g., the first control, the second control, and/or a third control different from the first control and the second control) of the plurality of controls.

While displaying the second user interface (e.g., 602, 618, 628, and/or 648) that includes the plurality of the controls (e.g., 606, 608, 610, 612, 626, 628, 652, and/or 654), the representation of the second value (e.g., 646b and/or 622b), and the second background (e.g., 632) that has the second visual appearance, the computer system detects (822) a request (e.g., 605f) (e.g., a set of one or more user inputs including an input of a second type and, In some embodiments, the second type is different from the first type) to change the second value to a third value that is different from the second value.

In response to detecting the request (e.g., 605d and/or 605f) to change the second value to the third value, the computer system displays (824) a representation of a third value (e.g., 622b, 646b) without displaying the representation of the second value (e.g., while continuing to display the second background and/or without changing the second background). In some embodiments, the representation of the third value is different from the representation of the second value due to the values being different. In some embodiments, how the third value and the second value are being represented are the same and the difference in value is what makes the representations different. In some embodiments, the third value corresponds to the first control and not the second control.

While displaying the plurality of controls (e.g., 606, 608, 610, 612, 626, 628, 652, and/or 654), the representation of the third value (e.g., 622b, 646b), and the second background (e.g., 632) that has the second visual appearance, the computer system detects (826) an input (e.g., 605c and/or 605e) (e.g., a tap input and/or a non-tap input (e.g., a gaze input, an air gesture, a pointing gesture a swipe input, and/or a mouse click)) (e.g., the first type of input) directed to the second control (e.g., 606, 608, 610, 612, 626, 628, 652, and/or 654).

In response to detecting the second control, the computer system displays (828) a modified version of the first user interface (e.g., 602, 618, 628, and/or 648) that includes the plurality of controls (e.g., 606, 608, 610, 612, 626, 628, 652, and/or 654), the representation of the first value (e.g., 622b, 646b), and the first background (e.g., 632), wherein the first background (e.g., 632) has a third visual appearance (e.g., that is based on the third value and not based on the second value) that is different from the first visual appearance and the second visual appearance, without having the first visual appearance and the second visual appearance. Displaying a representation of a third value without displaying the representation of the second value and changing an appearance of a background in response to detecting the request to change the second value to the third value provides a user with visual feedback regarding the state of the computer system (e.g., the computer system detects the request to change the second value to the third value), thereby providing improved visual feedback. Changing a representation of a value that is being displayed along with a background in response to detecting the input directed to the first control allows for a user interface to reflect information in not only representations but also backgrounds, thereby providing improved visual feedback, reducing the number of inputs needed to perform an operation (e.g., view particular information), providing additional control options (e.g., to view additional information) without cluttering the user interface with additional displayed controls, and/or performing an operation (e.g., view particular information) when a set of conditions has been met without requiring further user input.

In some embodiments, after displaying the first background (e.g., 632) with the first visual appearance and in accordance with a determination that a first environmental condition changes (e.g., change in temperature, sound, light, and/or windspeed) in a first manner (e.g., increase by an amount and/or decrease by an amount), the computer system changes (e.g., without and/or not in response to detecting input via an input mechanism in communication with the computer system (e.g., a tap input and/or a non-tap input (e.g., a gaze input, an air gesture, a pointing gesture a swipe input, and/or a mouse click))) (e.g., automatically without intervening user input) the first background from the first visual appearance to a fourth visual appearance that is different than the first visual appearance (e.g., increasing and/or decreasing a color, opacity, hue, size, and/or tint of the background) (e.g., as explained above at FIG. 2D). In some embodiments, after displaying the first background with the first visual appearance and in accordance with a determination that the first environmental condition changes (e.g., change in temperature, sound, light, and/or windspeed) in a second manner (e.g., increase by an amount and/or decrease by an amount), the computer system changes (e.g., without and/or not in response to detecting input via an input mechanism in communication with the computer system (e.g., a tap input and/or a non-tap input (e.g., a gaze input, an air gesture, a pointing gesture a swipe input, and/or a mouse click))) (e.g., automatically without intervening user input) the first background from the first visual appearance to a fifth visual appearance that is different from the first visual appearance (e.g., increasing and/or decreasing a color, opacity, hue, size, and/or tint of the background) (e.g., as explained above at FIG. 2D). Automatically changing the visual appearance of the first background when certain prescribed conditions are satisfied (e.g., when environmental conditions change) allows the computer system to indicate to a user detected changes in the conditions of the environment environmental conditions, thereby performing an operation when a set of conditions has been met without requiring further user input.

In some embodiments, after displaying the first background (e.g., 632) with the first visual appearance and in accordance with a determination that a second environmental condition (e.g., the first environmental condition or a different environmental condition) changes in a third manner (e.g., the first manner, the second manner, or a manner different from the first manner and the second manner), the computer system forgoes changing the appearance of the first background (e.g., as explained in FIG. 2D) (e.g., continuing to display the first background in the first visual appearance). Forgoing changing the appearance of the display of the first background allows the computer system to forgo performing a respective display operation each time there is a detected change in the condition of the environment, thereby performing an operation when a set of conditions has been met without requiring further user input.

In some embodiments, the first visual appearance of the first background (e.g., 632) is based on the second value (e.g., as explained above at FIGS. 2E and 2H) (e.g., and not the first value). In some embodiments, the second visual appearance of the second background is not based on the second value (e.g., as explained above at FIGS. 2E and 2H) (e.g., and not based on the first value). In some embodiments, the second visual appearance of the second background is not based on a value of a setting such that an appearance of the second background changes as a value of the setting changes. Displaying the first background with the first visual appearance that is based on the second value and displaying the second visual appearance of the second background that is not based on the second value allows the computer to selectively provide the user with visual feedback with respect to a status of a value, thereby performing an operation when a set of conditions has been met without requiring further user input and providing improved visual feedback.

In some embodiments, while displaying the second user interface (e.g., 602, 618, 628, and/or 648), a media item (e.g., media item represented by 624) (e.g., music, podcast, television show, and/or movie) is playing (e.g., the media item is being played back by the computer system or an external playback device). In some embodiments, the second visual appearance of the second background is based on the media item (e.g., as described above at FIG. 2B) (e.g., the second visual appearance corresponds to album art of the media item). Displaying the second user interface with the second background that has the second visual appearance based on a media item that is playing provides a user with visual feedback regarding which media item a playback device is currently playing, thereby providing improved visual feedback.

In some embodiments, in response to detecting the request to change the second value to the third value (e.g., 605d and/or 605f), the computer system continues to display the second background with the second visual appearance (e.g., as explained above at FIG. 2E) (e.g., the request to change the second value to the third value does not change the second visual appearance of the second background). Continuing to display the second background with the second visual appearance in response to detecting the request to change the second value to the third value allows a user to easily view information included in the second user interface, which aids in conveying information, thereby providing improved visual feedback, reducing the number of inputs needed to perform an operation, and/or performing an operation when a set of conditions has been met without requiring further user input.

In some embodiments, while displaying the first user interface (e.g., 602, 618, 628, and/or 648), the computer system detects a request to change the first value to a fourth value that is different from the first value. In some embodiments, as a part of detecting the request to change the first value to the fourth value, the computer system detects an input (e.g., a tap input and/or a non-tap input (e.g., a gaze input, an air gesture, a pointing gesture a swipe input, and/or a mouse click)) directed to a control. In some embodiments, in response to detecting the request to change the first value to the fourth value, the computer system causes output of a device to change. In some embodiments, the fourth value is different from the first value. In some embodiments, in response to detecting the request to change the first value to the fourth value, the computer system continues to display the first background (e.g., 632) with the first visual appearance (e.g., the request to change the first value to the fourth value does not change the second visual appearance of the second background). In some embodiments, in response to detecting the request to change the first value to the fourth value, the computer system ceases display of the representation of the first value and displays a representation of the fourth value. Displaying the representation of the fourth value in response to detecting the request to change the first value to the fourth value provides the user with visual feedback regarding the state of the computer system (e.g., the computer system detects the request to change the first value to the fourth value, thereby providing improved visual feedback.

In some embodiments, the computer system (e.g., 600) is in communication with an electronic device, In some embodiments, the request to change the second value to the third value (e.g., 605d and/or 605f) corresponds to changing a setting (e.g., volume, temperature, speed, and/or position) of the electronic device, and wherein the plurality of controls (e.g., 606, 608, 610, 612, 626, 628, 652, and/or 654) includes a third control (e.g., 606, 608, 610, 612, 626, 628, 652, and/or 654). In some embodiments, while displaying the modified version of the first user interface (e.g., 602, 618, 628, and/or 648), the computer system detects a second input (e.g., 605b2 and/or 605b1) (e.g., a tap input and/or a non-tap input (e.g., a gaze input, an air gesture, a pointing gesture a swipe input, and/or a mouse click)) directed to the third control. In some embodiments, in response to detecting the second input directed to the third control, the computer system displays a third user interface (e.g., 602, 618, 628, and/or 648) that includes a second plurality of controls (e.g., 606, 608, 610, 612, 626, 628, 652, and/or 654), wherein the second plurality of controls includes the first control (e.g., 606, 608, 610, 612, 626, 628, 652, and/or 654), and wherein displaying the third user interface includes: in accordance with a determination that the request to change the second value to the third value corresponds to changing a first setting of the electronic device, animating the first control (e.g., in a first manner and/or in a first way) based on the change of the first setting of the electronic device from the second value to the third value (e.g., as described above at FIG. 2H) and in accordance with a determination that the request to change the second value to the third value corresponds to changing a second setting of the electronic device, animating the first control (e.g., differently) (e.g., in a second manner different from the first manner and/or in a second way that is different from the first way) based on the change of the second setting of the electronic device from the second value to the third value. In some embodiments, the second plurality of controls are the same as the first plurality of controls (e.g., as described above at FIG. 2H) Automatically animating a portion of the first control based on which setting of the electronic device is changed allows the computer system to automatically perform a display operation that indicates to a user which setting of the electronic device is changed and the magnitude of the change of the setting of the electronic device, thereby performing an operation when a set of conditions has been met without requiring further user input.

In some embodiments, displaying the third user interface (e.g., 602, 618, 628, and/or 648) includes: in accordance with a determination that the request (e.g., 605d and/or 605f) to change the second value to the third value corresponds to changing the first setting of the electronic device, animating the first control (e.g., 606, 608, 610, 612, 626, 628, 652, and/or 654) in a third manner based on the request to change the second value to the third value (e.g., as described above at FIG. 2H). In some embodiments, in accordance with a determination that the request to change the second value to the third value corresponds to changing a third setting (e.g., a setting of the electronic device, such as the second setting or a different setting) (e.g., a setting of a device different from the electronic device) different from the first setting, the computer system animates the first control in a fourth manner that is different from the third manner, based on the request to change the second value to the third value. In some embodiments, animating the first control in the third manner includes changing a first portion of the first control without changing a second portion of the first control. In some embodiments, animating the first control in the fourth manner includes forgoing changing the first portion of the first control without changing the second portion of the first control. Automatically changing the first portion of the first control when a set of conditions are met without changing the second portion of the first control allows the computer system to automatically perform a display operation that indicates to a user which setting of the electronic device is modified, thereby performing an operation when a set of conditions has been met without requiring further user input.

In some embodiments, in accordance with a determination that the request (e.g., 605d and/or 605f) to change the second value to the third value corresponds to changing the second setting of the electronic device, animating the first control (e.g., 606, 608, 610, 612, 626, 628, 652, and/or 654) in a fifth manner that is different from the third manner, based on the request to change the second value to the third value (e.g., as described above at FIG. 2H). In some embodiments, animating the first control in the fifth manner includes changing the second portion of the first control without changing the first portion of the control. Animating the first control differently depending on whether the request to change the second value to the third value corresponds to changing the second setting of the electronic device allows the computer system to automatically perform a display operation that indicates to a user which setting of the electronic device is modified, thereby performing an operation when a set of conditions has been met without requiring further user input.

In some embodiments, the second plurality of controls (e.g., 606, 608, 610, 612, 626, 628, 652, and/or 654) includes at least a fifth control (e.g., 606, 608, 610, 612, 626, 628, 652, and/or 654) and a sixth control (e.g., 606, 608, 610, 612, 626, 628, 652, and/or 654). In some embodiments, the fifth control and the sixth control are not animated based on changes to a setting (e.g., as described above at FIG. 2H) (and/or, in some embodiments, changes detected in the physical environment).

Note that details of the processes described above with respect to process 800 (e.g., FIG. 4) are also applicable in an analogous manner to other methods described herein. For example, process 900 optionally includes one or more of the characteristics of the various methods described above with reference to process 800. For example, the plurality of controls can be displayed using one or more techniques described above in relation to process 700, where the appearance of the plurality of controls can change based on a change to a value of a setting using one or more techniques described above in relation to process 800. For brevity, these details are not repeated below.

FIG. 5 is a flow diagram illustrating a method (e.g., process 900) for displaying controls for different devices in accordance with some examples. Some operations in process 900 are, optionally, combined, the orders of some operations are, optionally, changed, and some operations are, optionally, omitted.

As described below, process 900 provides an intuitive way for displaying controls for different devices. Process 900 reduces the cognitive burden on a user for displaying controls for different devices, thereby creating a more efficient human-machine interface. For battery-operated computing devices, enabling a user to display controls for different devices faster and more efficiently conserves power and increases the time between battery charges.

In some embodiments, process 900 is performed at a computer system (e.g., 600) that is in communication with a display component (e.g., 604) (e.g., a display screen and/or a touch-sensitive display). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

The computer system displays (902), via the display component (e.g., 604), a first control (e.g., 606, 608, 610, 612, 626, 628, 652, and/or 654) for controlling a first type of device. In some embodiments, the first control, when interacted with in a first manner, controls a respective device of the first type of device. In some embodiments, the first control, when interacted with in a first manner controls a plurality of devices (e.g., the first device and the second device) of the first type of device.

While displaying the first control (e.g., 606, 608, 610, 612, 626, 628, 652, and/or 654) for controlling the first type of device, the computer system detects (904) an input (e.g., 605a, 605b1, 605b2, 605c, 605d, and/or 605e) (e.g., a tap input and/or a non-tap input (e.g., a gaze input, an air gesture, a pointing gesture a swipe input, and/or a mouse click)) directed to the first control. In some embodiments, the input directed to the first control is in a second manner different from the first manner.

In response to detecting the input (e.g., 605a, 605b1, 605b2, 605c, 605d, and/or 605e) directed to the first control (e.g., 606, 608, 610, 612, 626, 628, 652, and/or 654), the computer system displays (906), via the display component (e.g., 604): a second control (908) (e.g., 606, 608, 610, 612, 626, 628, 652, and/or 654) corresponding to a first device of the first type of device (e.g., a window, a thermostat, a light, a door, a fan, and/or a speaker), wherein the first device corresponds to (e.g., associated with, located at, and/or programmatically assigned to) a first location (e.g., right location, right side, front side, back side, or rear side) (e.g., as described above at FIG. 2I); a third control (910) (e.g., 606, 608, 610, 612, 626, 628, 652, and/or 654) corresponding to a second device of the first type of device, wherein the second device is different from the first device, and wherein the second device corresponds to (e.g., associated with, located at, and/or programmatically assigned to) a second location (e.g., right location, right side, front side, back side, or rear side) that is different from the first location (e.g., as described above at FIG. 2I) where in accordance with (912) a determination that presence of a user is detected at the first location, an indication that the second control (e.g., 606, 608, 610, 612, 626, 628, 652, and/or 654) is selected (e.g., bolding, highlighting, emphasizing, displaying a focus indicator, and/or displaying a box that surrounds) without displaying an indication that the third control (e.g., 606, 608, 610, 612, 626, 628, 652, and/or 654) is selected (e.g., not bolding, highlighting, emphasizing, displaying a focus indicator, and/or displaying a box that surrounds) (e.g., as described above at FIG. 2I) and where in accordance with (914) a determination that presence of the user is detected at the second location, the indication that the third control (e.g., 606, 608, 610, 612, 626, 628, 652, and/or 654) is selected without displaying the indication that the second control (e.g., 606, 608, 610, 612, 626, 628, 652, and/or 654) is selected (e.g., as described above at FIG. 2I). Automatically displaying an indication that a respective control is selected when prescribed conditions are satisfied allows the computer system to perform a display operation that indicates to a user whether the second control or the third control is selected, thereby performing an operation when a set of conditions has been met without requiring further user input and/or providing improved visual feedback.

In some embodiments, displaying the indication that the second control (e.g., 606, 608, 610, 612, 626, 628, 652, and/or 654) is selected includes emphasizing (e.g., highlighting, bolding, enlarging, brightening, displaying a glowing animation, moving, and/or shaking) the second control. In some embodiments, displaying the indication that the third control (e.g., 606, 608, 610, 612, 626, 628, 652, and/or 654) is selected includes emphasizing (e.g., highlighting, bolding, enlarging, brightening, displaying a glowing animation, moving, and/or shaking) the third control (e.g., as described above at FIG. 2I). Emphasizing a control based on which control is selected allows the computer system to selectively provide visual feedback with respect to the detected location of the user and a control corresponding to the detected location, thereby performing an operation when a set of conditions has been met without requiring further user input and/or providing improved visual feedback.

In some embodiments, the computer system (e.g., 600) is in communication with a first rotatable input mechanism (e.g., 616). In some embodiments, in accordance with a determination that the presence of the user is detected at the first location, the computer system configures the first rotatable input mechanism to control the first device at the first location (e.g., without configuring the first rotatable input mechanism to control the second device) (e.g., described above at FIG. 2I). In some embodiments, in accordance with a determination that the presence of the user is detected at the second location, the computer system configures the first rotatable input mechanism to control the second device at the second location (e.g., described above at FIG. 2I) (e.g., without configuring the first rotatable input mechanism to control the first device). Automatically configuring the rotatable input mechanism based on the detected location of the user allows the computer system to selectively configure the rotatable input mechanism such that the rotatable input mechanism is configured to control a device that is of increased interest, thereby performing an operation when a set of conditions has been met without requiring further user input.

In some embodiments, while the first rotatable input mechanism (e.g., 616) is configured to control the first device, the computer system detects a second input (e.g., 605d) (e.g., a tap input and/or a non-tap input (e.g., a gaze input, an air gesture, a pointing gesture a swipe input, and/or a mouse click)) that corresponds to selection of the first rotatable input mechanism. In some embodiments, in response to detecting the second input, the computer system causes the first device to perform an operation (e.g., without causing the second device to perform an operation) (e.g., as described above at FIG. 2I). In some embodiments, causing the first device to perform an operation includes sending an instruction to the first device to perform the operation. In some embodiments, while the first rotatable input mechanism is configured to control the second device, the computer system detects a second input that corresponds to selection of the first rotatable input mechanism. In some embodiments, in response to detecting the second input, the computer system causes the second device to perform an operation (e.g., without causing the first device to perform an operation). Causing the first device to perform an operation when detecting the second input that corresponds to selection of the first rotatable input mechanism allows the computer system to control devices that are external to the computer system without the computer system displaying additional user interface objects, thereby providing additional controls options without cluttering the user interface with additional displayed controls.

In some embodiments, while the first rotatable input mechanism (e.g., 616) is configured to control the first device, the computer system detects a third input (e.g., 605a, 605b1, 605b2, 605c, 605d, and/or 605e) (e.g., a tap input and/or a non-tap input (e.g., a gaze input, an air gesture, a pointing gesture a swipe input, and/or a mouse click)) that corresponds to selection of the third control (e.g., 606, 608, 610, 612, 626, 628, 652, and/or 654). In some embodiments, in response to detecting the third input, the computer system configures the first rotatable input mechanism to control the second device (e.g., as described above at FIG. 2J) (e.g., without the first rotatable input mechanism being configured to control the first device). Configuring the first rotatable input mechanism to control the second device in response to detecting the third input provides the user with control over the computer system to choose which device that the physical input mechanism is configured to control, thereby providing additional control options without cluttering the user interface with additional displayed controls.

In some embodiments, in response to detecting the input (e.g., 605a, 605b1, 605b2, 605c, 605d, and/or 605e) directed to the first control (e.g., 606, 608, 610, 612, 626, 628, 652, and/or 654) and in accordance with a determination that the presence of the user is detected at the first location, the computer system displays a first set of controls (e.g., 656 and/or 658) that corresponds to the first device (and, in some embodiments, that do not correspond to the second device) (e.g., display window and tint concurrently with left and right window options) (e.g., as described above at FIGS. 21 and 2J). In some embodiments, in response to detecting the input directed to the first control and in accordance with a determination that the presence of the user is detected at the second location, the computer system displays a second set of controls (e.g., 656 and/or 658) (e.g., as described above at FIGS. 21 and 2J) that corresponds to the second device (and, in some embodiments, that do not correspond to the first device) (e.g., display window and tint concurrently with left and right window options). In some embodiments, the first set of controls and the second set of controls are comprised of the same number of controls and/or the same types of controls (e.g., window up, window down, and/or window tint). In some embodiments, the first set of controls includes a control that, when selected, control a right window. In some embodiments, the first set of controls includes a control that, when selected, control a left window. Automatically displaying a respective set of controls based on the location of the user allows the computer system to automatically display controls corresponding to a device that is most relevant, thereby performing an operation when a set of conditions has been met without requiring further user input.

In some embodiments, while the indication that the second control (e.g., 606, 608, 610, 612, 626, 628, 652, and/or 654) is selected is displayed, the computer system detects a fourth input (e.g., 605i) (e.g., a tap input and/or a non-tap input (e.g., a gaze input, an air gesture, a pointing gesture a swipe input, and/or a mouse click)) that corresponds to selection of the third control (e.g., 606, 608, 610, 612, 626, 628, 652, and/or 654). In some embodiments, in response to detecting the fourth input, the computer system displays a third set of controls that corresponds to the second device (e.g., 656 and/or 658) (e.g., as described above at FIG. 2J). Displaying a third set of controls in response to detecting the fourth input provides the user with visual feedback regarding the state of the computer system (e.g., the computer system has detected the fourth input) and provides the user with control over the computer system to choose which controls are displayed, thereby providing improved visual feedback and/or providing additional control options without cluttering the user interface with additional displayed controls.

In some embodiments, while displaying the indication that the second control (e.g., 606, 608, 610, 612, 626, 628, 652, and/or 654) is selected, the computer system detects a fifth input (e.g., 605i) (e.g., a tap input and/or a non-tap input (e.g., a gaze input, an air gesture, a pointing gesture a swipe input, and/or a mouse click)) that corresponds to selection of the third control (e.g., 606, 608, 610, 612, 626, 628, 652, and/or 654). In some embodiments, in response to detecting the fifth input, the computer system ceases to display the indication that the second control is selected. In some embodiments, in response to detecting the fifth input, the computer system displays the indication that the third control is selected. (e.g., as described above at FIG. 2J) Ceasing to display the indication that the second control is selected and displaying an indication that the third control is selected in response to detecting the fifth input provides the user with visual feedback regarding the selection status of both the second control and the third control, thereby providing improved visual feedback.

In some embodiments, in response to detecting the input directed to the first control (e.g., 606, 608, 610, 612, 626, 628, 652, and/or 654), the computer system displays a representation of a scale (e.g., 658), wherein the representation of the scale is displayed before detecting the fifth input and after detecting the fifth input (e.g., as described above at FIG. 2J). Displaying the scale before and after detection of the fifth input allows a user to avoid performing inputs such that the computer system will redisplay the scale each time the second or third control is selected, thereby reducing the number of inputs needed to perform an operation.

In some embodiments, before detecting the fifth input (e.g., 605i), the representation of the scale (e.g., 658) is displayed with a first value that corresponds to the first device. In some embodiments, the computer system (e.g., 600) is in communication with a second physical input mechanism (e.g., 616) (e.g., rotatable input mechanism and/or pressable input mechanism). In some embodiments, the representation of the scale is displayed at least partially (or fully) around the second physical input mechanism (e.g., as described above at FIG. 2I).

In some embodiments, while displaying the second control (e.g., 606, 608, 610, 612, 626, 628, 652, and/or 654) and the third control (e.g., 606, 608, 610, 612, 626, 628, 652, and/or 654), the computer system detects a sixth input (e.g., 605i) (e.g., a tap input and/or a non-tap input (e.g., a gaze input, an air gesture, a pointing gesture a swipe input, and/or a mouse click)) that corresponds to selection of the third control (e.g., 606, 608, 610, 612, 626, 628, 652, and/or 654). In some embodiments, in response to detecting the sixth input and in accordance with a determination that the user is detected at the first location, the computer system continues displaying the second control and the third control (e.g., as described above at FIG. 2J). In some embodiments, in response to detecting the sixth input and in accordance with a determination that the user is not detected at the first location, the computer system ceases displaying the second control and/or the third control. Continuing to display the second control and the third control after the computer system detects a sixth input that corresponds to selection of the third control allows a user to avoid needing to perform an input such that the computer system will redisplay the second control and the third control each time a respective control is selected, thereby reducing the number of inputs needed to perform an operation.

In some embodiments, in response to detecting the input directed to the first control (e.g., 606, 608, 610, 612, 626, 628, 652, and/or 654), the computer system displays, via the display component (e.g., 604), a fourth control (e.g., 660). In some embodiments, while displaying the fourth control, the computer system detects a seventh input (e.g., a tap input and/or a non-tap input (e.g., a gaze input, an air gesture, a pointing gesture a swipe input, and/or a mouse click)) that corresponds to selection of the fourth control. In some embodiments, in response to detecting the seventh input, the computer system ceases to display the second control (e.g., 606, 608, 610, 612, 626, 628, 652, and/or 654) and the third control (e.g., 606, 608, 610, 612, 626, 628, 652, and/or 654) (e.g., as described above at FIG. 2II). Ceasing to display the second control and the third control in response to detecting the seventh input provides the user with visual feedback regarding the state of the computer system (e.g., that the computer system has detected the seventh input), thereby providing improved visual feedback.

In some embodiments, the first type of device is a window (and/or a window actuator).

Note that details of the processes described above with respect to process 900 (e.g., FIG. 5) are also applicable in an analogous manner to the methods described herein. For example, the plurality of controls can be displayed using one or more techniques described above in relation to process 700, where the plurality of controls correspond to different devices using one or more techniques described above in relation to process 900. For brevity, these details are not repeated below.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

1.-41. (canceled)

42. A method, comprising:
at a computer system that is in communication with a display component:
displaying, via the display component, a first control for controlling a first type of device;
while displaying the first control for controlling the first type of device, detecting an input directed to the first control; and
in response to detecting the input directed to the first control, displaying, via the display component:
a second control corresponding to a first device of the first type of device, wherein the first device corresponds to a first location;
a third control corresponding to a second device of the first type of device, wherein the second device is different from the first device, and wherein the second device corresponds to a second location that is different from the first location;
in accordance with a determination that presence of a user is detected at the first location, an indication that the second control is selected without displaying an indication that the third control is selected; and
in accordance with a determination that presence of the user is detected at the second location, the indication that the third control is selected without displaying the indication that the second control is selected.

43. The method of claim 1, wherein displaying the indication that the second control is selected includes emphasizing the second control, and wherein displaying the indication that the third control is selected includes emphasizing the third control.

44. The method of claim 1, wherein the computer system is in communication with a first rotatable input mechanism, the method further comprising:
in accordance with a determination that the presence of the user is detected at the first location, configuring the first rotatable input mechanism to control the first device at the first location; and
in accordance with a determination that the presence of the user is detected at the second location, configuring the first rotatable input mechanism to control the second device at the second location.

45. The method of claim 3, further comprising:
while the first rotatable input mechanism is configured to control the first device, detecting a second input that corresponds to selection of the first rotatable input mechanism; and
in response to detecting the second input, causing the first device to perform an operation.

46. The method of claim 3, further comprising:
while the first rotatable input mechanism is configured to control the first device, detecting a third input that corresponds to selection of the third control; and
in response to detecting the third input, configuring the first rotatable input mechanism to control the second device.

47. The method of claim 1, further comprising:
in response to detecting the input directed to the first control:
in accordance with a determination that the presence of the user is detected at the first location, displaying a first set of controls that corresponds to the first device; and
in accordance with a determination that the presence of the user is detected at the second location, displaying a second set of controls that corresponds to the second device.

48. The method of claim 1, further comprising:
while the indication that the second control is selected is displayed, detecting a fourth input that corresponds to selection of the third control; and
in response to detecting the fourth input, displaying a third set of controls that corresponds to the second device.

49. The method of claim 1, further comprising:
while displaying the indication that the second control is selected, detecting a fifth input that corresponds to selection of the third control; and
in response to detecting the fifth input:
ceasing to display the indication that the second control is selected; and
displaying the indication that the third control is selected.

50. The method of claim 8, further comprising:
in response to detecting the input directed to the first control, displaying a representation of a scale, wherein the representation of the scale is displayed before detecting the fifth input and after detecting the fifth input.

51. The method of claim 9, wherein, before detecting the fifth input, the representation of the scale is displayed with a first value that corresponds to the first device, the method further comprising:
In response to detecting the fifth input, adjusting the display of the representation of the scale from including an appearance based on the first value to including an appearance based on a second value different from the first value.

52. The method of claim 8, wherein the computer system is in communication with a second physical input mechanism, and wherein the representation of the scale is displayed at least partially around the second physical input mechanism.

53. The method of claim 1, further comprising:
while displaying the second control and the third control, detecting a sixth input that corresponds to selection of the third control; and
in response to detecting the sixth input and in accordance with a determination that the user is detected at the first location, continuing displaying the second control and the third control.

54. The method of claim 1, further comprising:
in response to detecting the input directed to the first control, displaying, via the display component, a fourth control;
while displaying the fourth control, detecting a seventh input that corresponds to selection of the fourth control; and
in response to detecting the seventh input, ceasing to display the second control and the third control.

55. The method of claim 1, wherein the first type of device is a window.

56.-63. (canceled)

64. A non-transitory computer-readable storage medium storing one or more programs configured to be executed by one or more processors of a computer system that is in communication with a display component, the one or more programs including instructions for:
displaying, via the display component, a first control for controlling a first type of device;
while displaying the first control for controlling the first type of device, detecting an input directed to the first control; and
in response to detecting the input directed to the first control, displaying, via the display component:
a second control corresponding to a first device of the first type of device, wherein the first device corresponds to a first location;
a third control corresponding to a second device of the first type of device, wherein the second device is different from the first device, and wherein the second device corresponds to a second location that is different from the first location;
in accordance with a determination that presence of a user is detected at the first location, an indication that the second control is selected without displaying an indication that the third control is selected; and
in accordance with a determination that presence of the user is detected at the second location, the indication that the third control is selected without displaying the indication that the second control is selected.

65. A computer system that is in communication with a display component, comprising:
one or more processors; and
memory storing one or more programs configured to be executed by the one or more processors, the one or more programs including instructions for:
displaying, via the display component, a first control for controlling a first type of device;
while displaying the first control for controlling the first type of device, detecting an input directed to the first control; and
in response to detecting the input directed to the first control, displaying, via the display component:
a second control corresponding to a first device of the first type of device, wherein the first device corresponds to a first location;
a third control corresponding to a second device of the first type of device, wherein the second device is different from the first device, and wherein the second device corresponds to a second location that is different from the first location;
in accordance with a determination that presence of a user is detected at the first location, an indication that the second control is selected without displaying an indication that the third control is selected; and
in accordance with a determination that presence of the user is detected at the second location, the indication that the third control is selected without displaying the indication that the second control is selected.
